(19) United States
(12) Patent Application Publication
(10) Pub. No.: US 2025/0356366 A1
(43) Pub. Date: Nov. 20, 2025

(54) METHODS AND APPARATUS TO FACILITATE CONSUMER ACTIONS USING QUICK RESPONSE (QR) CODES

(71) Applicant: Returned.com, Inc., Boulder, CO (US)

(72) Inventors: Patrick A. Justis, Longmont, CO (US); Paul Pao-Yen Lin, Boulder, CO (US)

(21) Appl. No.: 18/903,750

(22) Filed: Oct. 1, 2024

Related U.S. Application Data
(60) Provisional application No. 63/648,633, filed on May 16, 2024.

(51) Int. Cl. G06Q 30/016; G06Q 20/38

(52) U.S. Cl. CPC G06Q 30/016; G06Q 20/385

(57) ABSTRACT

Systems, apparatus, articles of manufacture, and methods to facilitate returns using business to business to consumer QR codes are disclosed. Example instructions, when executed, cause at least one processor circuit to generate a quick-response (QR) code based on order information corresponding to an order for a product from a retailer, the retailer being at least one entity included in a sale or a provision of a good or service; provide the QR code to the retailer, the retailer to include the QR code in a shipment of the order; cause display of a first user interface in response to a scan of the QR code, the first user interface including the order information and one or more selectable consumer actions; and after selection of a selected consumer action of the one or more selectable consumer actions, cause coordination of the selected consumer action.

### RELATED APPLICATION

This patent claims the benefit of U.S. Provisional Patent Application No. 63/648,633, which was filed on May 16, 2024. U.S. Provisional Patent Application No. 63/648,633 is hereby incorporated herein by reference in its entirety. Priority to U.S. Provisional Patent Application No. 63/648,633 is hereby claimed.

### FIELD OF THE DISCLOSURE

This disclosure relates generally to consumer advocacy and, more particularly, to methods and apparatus to facilitate consumer actions using quick response (QR) codes.

### BACKGROUND

In recent years, increases in commercialism and digital advertising have led to a rise in consumer purchasing. In many examples, a consumer may purchase a product and later desire to take any number of actions relating to the product, such as return the product or register the product for a warranty, among other things.

### BRIEF DESCRIPTION OF THE DRAWINGS

FIG. 1 is a block diagram of an example environment in which example consumer action circuitry interacts with a consumer action coordinator circuitry to facilitate consumer actions for a product.

FIG. 2 is a diagram illustrating an example flow of coordination of return of an item using the consumer action coordinator circuitry of FIG. 1.

FIG. 3 is a block diagram of an example implementation of the example consumer action coordinator circuitry of FIG. 1.

FIG. 4 is a block diagram of an example implementation of the example consumer action circuitry of FIG. 1.

FIG. 5 is a block diagram of an example implementation of the example retailer server of FIG. 1.

FIG. 6 is a flowchart representative of example machine readable instructions and/or example operations that may be executed, instantiated, and/or performed by example programmable circuitry to implement the consumer action coordinator circuitry of FIG. 1 to generate a QR code for an order.

FIG. 7A is a flowchart representative of example machine readable instructions and/or example operations that may be executed, instantiated, and/or performed by example programmable circuitry to implement the consumer action coordinator circuitry of FIG. 1 to provide proposed return coordination details to the consumer action circuitry.

FIG. 7B is a flowchart representative of example machine readable instructions and/or example operations that may be executed, instantiated, and/or performed by example programmable circuitry to implement the consumer action coordinator circuitry of FIG. 1 to interact with a retailer to coordinate return of an item.

FIG. 8 is an illustrative example of a packing slip with an example QR code.

FIG. 9A is an illustrative example of a consumer device accessing a URL hosted by the consumer action coordinator circuitry of FIG. 1 to display consumer actions.

FIG. 9B is an illustrative example of a consumer device accessing a URL hosted by the consumer action coordinator circuitry of FIG. 1 to display tracking for a return of an item.

FIG. 10 is a block diagram of an example processing platform including programmable circuitry structured to execute, instantiate, and/or perform the example machine readable instructions and/or perform the example operations of FIGS. 6, 7A, and/or 7B to implement the consumer action coordinator circuitry of FIG. 3.

FIG. 11 is a block diagram of an example processing platform including programmable circuitry structured to execute, instantiate, and/or perform the example machine readable instructions and/or perform the example operations represented by the flowchart of FIG. 2 to implement the consumer action circuitry of FIG. 4.

FIG. 12 is a block diagram of an example processing platform including programmable circuitry structured to execute, instantiate, and/or perform the example machine readable instructions and/or perform the example operations represented by the flowchart of FIG. 2 to implement the retailer server of FIG. 5.

FIG. 13 is a block diagram of an example implementation of the programmable circuitry of FIGS. 10, 11, and/or 12.

FIG. 14 is a block diagram of another example implementation of the programmable circuitry of FIGS. 10, 11, and/or 12.

FIG. 15 is a block diagram of an example software/firmware/instructions distribution platform (e.g., one or more servers) to distribute software, instructions, and/or firmware (e.g., corresponding to the example machine readable instructions of FIGS. 6, 7A, and/or 7B) to client devices associated with end users and/or consumers (e.g., for license, sale, and/or use), and/or retailers (e.g., for sale, re-sale, license, and/or sub-license).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

A consumer may decide to take a number of actions with respect to a purchased product. For example, a consumer may wish to return the product, register the product for a warranty offered by a retailer, leave a review for the product, request a price deduction, etc. A retailer of a product may want to provide information to a purchase such as a location where the product can be recycled, or a survey that can be completed. A consumer may wish to return a product with specific goals, such as to a) remove the returned product from their home as quickly as possible, b) maximize a monetary compensation for the value of the returned product, and/or c) return the product with minimal effort. In some examples, a consumer may prioritize one or more of the foregoing goals over the others and/or have a different goal. As used herein, a consumer may be additionally or alternatively referred to as a user.

Example methods, systems, and apparatus described herein enable actions to be taken by consumers in a manner that reduces complexity for the consumer, retailer, and third parties that may be involved in a process implicated by the consumer action. A retailer requests a quick-response (QR) code to be generated for an order received from a consumer. As used herein, a retailer is any entity involved in selling or providing a good or service. For example, a retailer may include a wholesale entity, a warehousing entity, a distribution entity, a logistics entity, an e-commerce entity, a manufacturing entity (e.g., an original equipment manufacturer (OEM)), etc. Consumer action coordinator circuitry generates the QR code based on the order information. The QR code encodes a uniform resource locator (URL) that enables a subsequent device (e.g., a user device, a consumer device, a courier device) to access a webpage that enables various actions (e.g., initiate a return, leave a review, register for a warranty, complete a survey, order again, etc.) to be taken with respect to an item (e.g., an item in the order). In examples disclosed herein, the QR code is included in a packing slip (e.g., printed on the packing slip). In some examples, respective ones of the plurality of QR codes correspond to each of the items purchased. The packing slip is included in the shipment of the order to the consumer. The packing slip enables the consumer to scan the QR code and to perform an action using the webpage identified by the QR code. The consumer action coordinator circuitry validates the QR code was scanned by the consumer and notifies the retailer. The webpage identified by the QR code is hosted at a consumer action coordinator circuitry, which enables the consumer to perform actions related to the order. The webpage provides proposed settings (e.g., return details) to the consumer. The consumer selects the action the consumer wishes to take. If the consumer wants to initiate a return, the consumer edits and/or accepts proposed return settings and requests coordination of the return. The example consumer action coordinator circuitry coordinates a return with the retailer on behalf of the consumer to determine a final destination for the product. The example consumer action coordinator circuitry also determines a transit plan to transport the package to the final destination and initiates the transit plan. The example consumer action coordinator circuitry provides return instructions to the consumer. Any number of individuals along the transit plan (e.g., employees at delivery services, individuals at intermediate destinations or the final destination, etc.) may scan the QR code on the transit package. Accordingly, the consumer action coordinator circuitry displays different information on the corresponding webpage based on the transit status of the package. As used herein, the term product is hereby defined as a good or a service. For example, a product may be a tangible product (e.g., a pair of shoes, a laptop computer, a food item). Alternatively, a product may be an intangible product (e.g., a digital asset, such as a non-fungible token (NFT), executable instructions, etc.). In some examples, a product may represent a subscription to a service (e.g., a continuously available service such as a television or media streaming service, a repeating service (e.g., a cleaning service), a one-time service, etc.). In some examples, a product may represent a right (e.g., a right to enter a venue, a right to play media, a right to use real estate, etc.). While the following examples are described in terms of return of a tangible product, such examples may be equally applicable to return of non-tangible products.

One factor that affects the user experience of returning a product is determining where the product should be sent. Some products are purchased using an e-commerce platform that offers products from a wide variety of sellers. In such examples, a consumer may use a first communication system to contact the e-commerce platform to determine where to return the product. In other examples, a user may digitally purchase a product directly from a seller. In such an example, each seller may have an independent communication system describing how to contact them and determine a location. Therefore, a user may be required to remember any number of different communication systems (e.g., which phone number to call, which application to open, which email to save, where a link is within an email, etc.) based on where the product is purchased. Maintaining information from such a diverse set of sources can add complexity to the return process and degrade the user experience.

In addition to engaging with various communication systems, engaging with various return policies can further complicate a user's ability to return a product. A business's decision to accept the return of a product may depend on any number of factors, including but not limited to the length of time since the original purchase, whether the product has been opened or used, the reason for the return, etc. As a result, some businesses may decide to accept a request to return a product while other businesses would not accept the same request to return the same product. If a business decides not to accept a returned product, the user may then have to decide whether to try selling the product themselves, recycle the product, donate the product, discard the product, etc. Accordingly, while a user may have multiple options for where to send a returned product, identifying said options can be a difficult task. Furthermore, each return option that a user can identify may satisfy one or more of the goals of the return differently from other return options.

Once a user does select a return option, initiating the transit of the product away from an initial destination (e.g., their home) poses an additional logistical challenge. In some examples, the user buys postage, determines the mass of the product, and affixes an appropriate number of stamps. In some examples, the user prints a specific shipping label and securely tapes the shipping label to a package. The user may additionally need to determine whether: a) they should bring the package to a drop-off location or b) the product will be picked up by a delivery service. Such steps may require an amount of cost, time, and effort from the user, thereby reducing the user experience and frustrating the goals of the return.

Consumers face many of the challenges (e.g., determining which entity the consumer needs to contact, interpreting policies, etc.) associated with a return of a product when trying to perform other actions, such as registering for a warranty or extending a lease for a product.

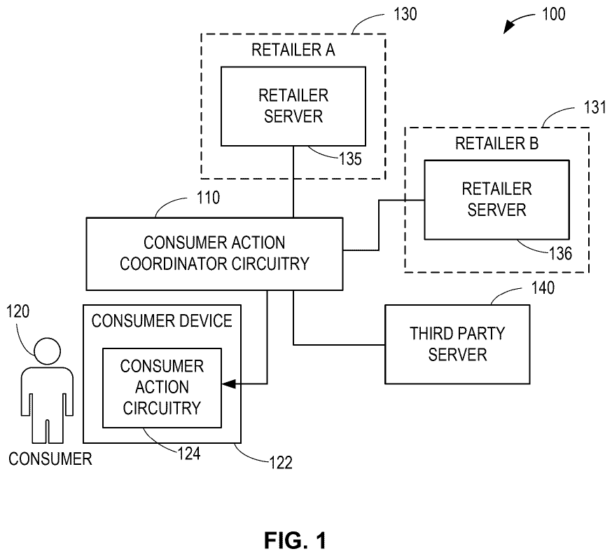

FIG. 1 is a block diagram of an example environment 100 in which example consumer action circuitry 124 interacts with a consumer action coordinator circuitry 110 to initiate an interaction with a retailer 130, 131. In the illustrated example of FIG. 1 the consumer action coordinator circuitry 110 interacts with one or more third-party servers 140 to identify purchased information of a consumer 120 from one or more retailers 130, 131. In some examples, the consumer action coordinator circuitry 110 may interact with a retailer server 135, 136 to obtain the purchase information of the consumer 120. Such purchase information may identify items that were purchased, services that are subscribed to by the consumer 120, date(s) of purchase, purchase prices, and/or any other details concerning past purchases of the consumer 120, etc.

The example third-party server 140 of the illustrated example of FIG. 1 may be implemented using an email server and/or service at which the consumer 120 may receive order confirmations (e.g., emails). In examples disclosed herein, the consumer 120 may provide authorization and/or login information to the consumer action coordinator circuitry 110 to enable the consumer action coordinator circuitry 110 to communicate with the third-party server 140 to collect such purchase information.

Upon collection and aggregation of the purchase information, the example consumer action coordinator circuitry 110 communicates the purchase information to the consumer action circuitry 124 of the consumer device 122. In the illustrated example of FIG. 1, the consumer device 122 represents a smart phone and/or tablet of the consumer. However, any other type of consumer device 122 may additionally or alternatively be used including, for example, laptop computers, desktop computers, smart watches, televisions, etc.

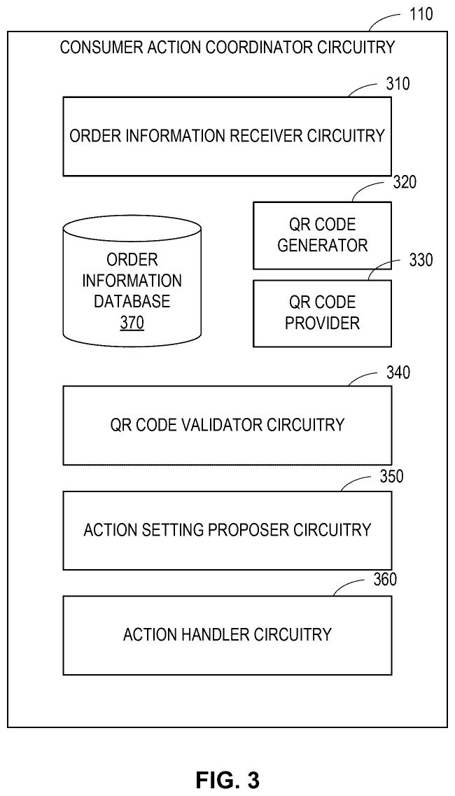

The example consumer action circuitry 124 of the illustrated example of FIG. 1 may be implemented using an application that is executed by the consumer device 122. Additionally or alternatively, the example consumer action circuitry 124 may be implemented in any other manner including, for example, within a browser of the example consumer device 122. An example implementation of the consumer action circuitry 124 is described in further detail below in connection with FIG. 3.

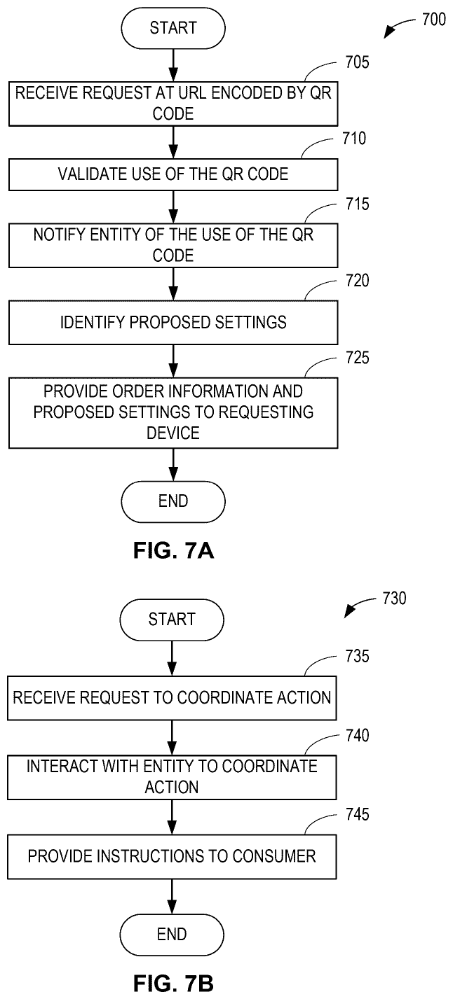

The example consumer action circuitry 124 the illustrated example of FIG. 1 enables presentation of a first user interface that lists goods the consumer can take an action for. An example representation of the first interface is described below in connection with FIG. 7. Whether or not a purchased good is displayed by the consumer action circuitry 124 is dependent upon one or more factors including, for example, a type of the product, policies of the retailer from which the good was purchased, the date of purchase, date of delivery, information concerning a history of the retailer accepting returns outside of their predefined return windows, etc. From the first user interface, the consumer 120 may select an item for which an action is to be taken. For example, the consumer 120 may select to return the item. In response to the selection, the example consumer action circuitry 124 communicates with the consumer action coordinator circuitry 110 to request proposed settings to be used for coordination of the action.

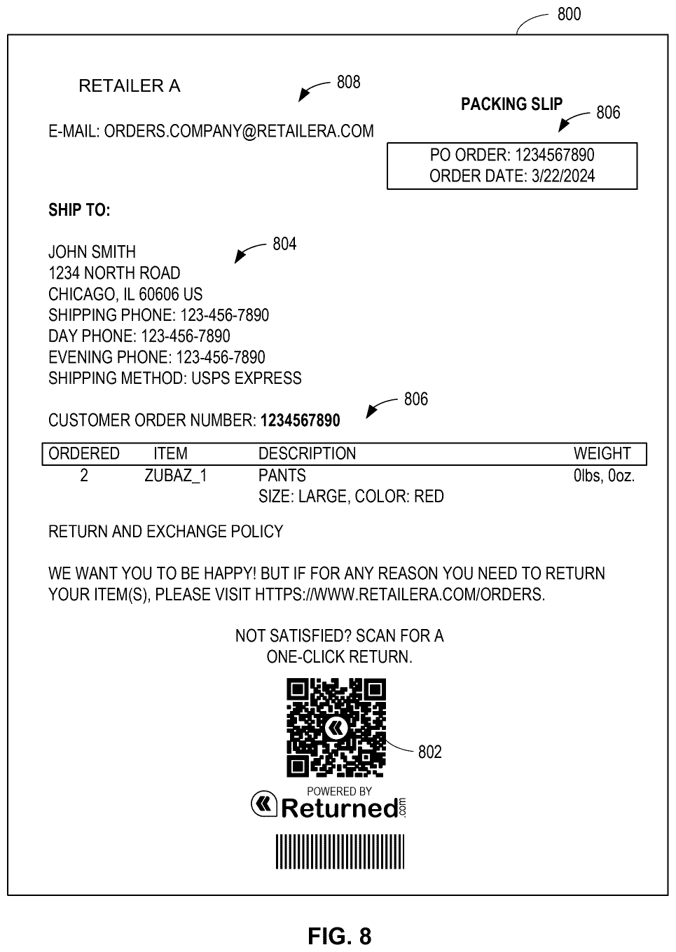

The example consumer action coordinator circuitry 110 determines such proposed settings and sends the proposed settings to the consumer action circuitry 124 for display to the consumer 120 in a second user interface. Such proposed settings, and/or modifications thereto, are then used by the consumer action coordinator circuitry 110 when interacting with the retailer and/or third parties. An example of the second interface is described below in connection with FIG. 8. Advantageously, the proposed settings may be learned over time based on user history, types of items, user preferences, knowledge of procedures for the specific action and/or trends with the entity, etc. As a result, many users may not need to adjust the proposed settings, resulting in an interaction where the user may simply click one button to initiate coordination of the action. For example, at the direction of the consumer 120 (e.g., in response to a user clicking an “initiate return” button), the consumer action circuitry 124 instructs the consumer action coordinator circuitry 110 to interact with the retailer from which the item was purchased to return the item. The example consumer action coordinator circuitry 110 conducts such interaction with the corresponding retailer in accordance with the return parameters provided by the consumer.

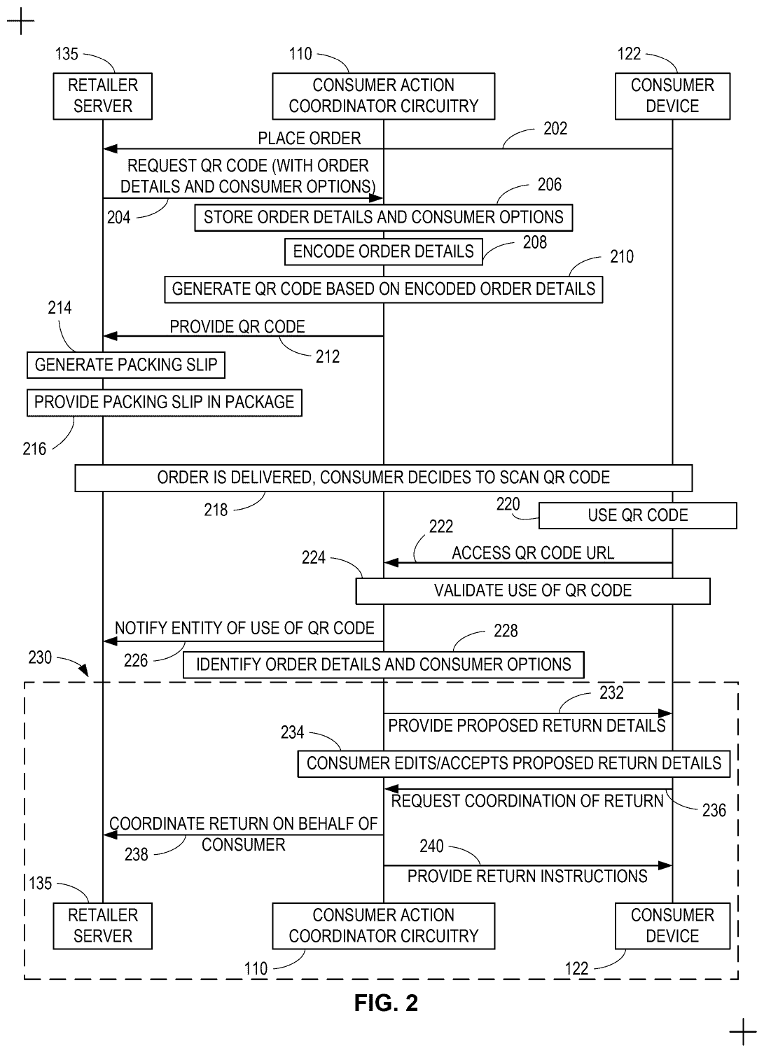

FIG. 2 is a diagram illustrating an example sequence for coordination of return of an item using the consumer action coordinator circuitry of FIG. 1. A consumer places an order (202) to the retailer server 135. In the illustrated example of FIG. 2, the consumer places the order via consumer device 122.

The retailer server 135 processes the order and requests a QR code be generated by the consumer action coordinator circuitry 110 for the order (204). In some examples, the retailer server 135 sends, along with the request for a QR code (e.g., the QR code request), order details (e.g., order information) pertaining to the order. In some examples, order information includes a name of the product, a weight of the product, a size of the product, a name of the retailer, an address of the retailer, a name of a recipient, a shipping address, etc. The retailer server 135 also sends actions available to the consumer with respect to products purchased once the consumer receives the order, such as initiating a return, or registering for a warranty. The options available to the consumer may be specific to the individual products. For example, the retailer may offer warranty registration for a first product in the order, but not a second product in the order. In some examples, the retailer server 135, after generation of a QR code by the consumer action coordinator circuitry 110, sends a consumer action modification request to at least one of add or remove consumer actions from the actions available to the consumer.

The consumer action coordinator circuitry 110 stores the order details and consumer options (206). For example, the consumer action coordinator circuitry 110 may store product information for each product in the order and the consumer options for each product in the order as a boolean (enabled or disabled) for each consumer option (e.g., return product, order product again, register warranty for product, etc.). In some examples, the consumer action coordinator circuitry 110 stores the order details and consumer options in an order information database.

The consumer action coordinator circuitry 110 encodes the order details (208). In some examples, the consumer action coordinator circuitry 110 encodes the order details as a webpage address, such as a URL. For example, the consumer action coordinator circuitry 110 encodes the order information as a computed identifier (e.g., Globally Unique Identifier (GIUD), hash-based identifier, composite key, Collision-resistant Unique Identifier (CUID), Nano ID, etc.) and includes the computed identifier in the webpage address. In some examples, the information encoded into the URL is separate from the order information. In some examples, the URL identifies a webpage hosted by the consumer action coordinator circuitry 110.

The URL that corresponds to the QR code may be formatted according to any suitable webpage communication protocol. For example, the URL may include headers including but not limited to HyperText Transfer Protocol (http), HTTP Secure (https), World Wide Web (www), etc. The URL may additionally include fields that provide parameters based on the corresponding communication protocol. Such parameters include but are not limited to the computed identifier discussed above.

In some examples, the consumer action coordinator circuitry 110 generates validation information (e.g., a validation code, a password, etc.) to be used during validation of the use of the QR code. In some examples, the validation information is generated based on the order information. The consumer action coordinator circuitry 110 generates a QR code based on the encoded order details (210). The QR code encodes a URL that enables the consumer device 122 to access a webpage hosted at the consumer action coordinator circuitry 110. In some examples, the consumer action coordinator circuitry 110 generates multiple QR codes based on the order information (and/or encoded order information). For example, the consumer action coordinator circuitry 110 may generate a first QR code for a first product in the order and a second QR code for a second product in the order.

The consumer can scan the QR code corresponding to the product for which they want to take an action. In another example, each of the QR codes corresponds to a specific action available to the consumer (e.g., a first QR code for returning a product. A QR code for leaving a review. The QR codes can be included on a single packing slip or on multiple packing slips. Accordingly, the retailer can include a first QR code enabling return of products in the order on a packing slip that explains a return policy of the retailer and include a second QR code to direct the consumer to take a survey on a promotional packing slip informing the consumer about a chance to win a prize for completing the survey. The QR code(s) may be any type, size, and/or resolution. The consumer action coordinator circuitry 110 provides the generated QR code to the retailer server 135 (212). In some examples, the consumer action coordinator circuitry 110 also provides validation information to the retailer server 135.

The retailer server 135 receives the QR code and generates a packing slip for the order including order information, the QR code, and validation information (214). An example packing slip generated by the retailer server 135 is illustrated in FIG. 8. In some examples, the retailer server 135 causes the packing slip to be included in the shipment of the order to the consumer (216).

Once the order, including the packing slip(s), is shipped to the consumer 120, the consumer may choose to take an action with respect to a product that was part of the order (218). The consumer uses the consumer device 122 to scan the QR code (220), resulting in the consumer device 122 accessing the URL (222). In some examples, the consumer cannot take any actions on the webpage until delivery of the order is confirmed. Limiting use of the webpage until the order has been delivered and the consumer has the opportunity to scan the package provides protection against fraudulent access of the webpage. The example consumer action coordinator circuitry 110 also validates is the webpage is being accessed by the consumer to protect against fraudulent use of the webpage (224). In some examples, the consumer action coordinator circuitry 110 validates webpage access using two-factor authentication, requires the consumer to answer a security question, and/or uses any other method of validation such as biometric authentication, entering a code (e.g., the validation information) included on the packing slip, etc. The consumer action coordinator circuitry 110 notifies the retailer server 135 of the URL access by the consumer (226). Notification of the scanning of the QR code by the consumer informs the retailer that the consumer received and opened the package. This offers extra protection for the retailer against potential claims by the consumer that the package was not received by the consumer.

After the QR code is scanned by the consumer, the consumer action coordinator circuitry 110 identifies the order details associated with the QR code (228). Once the order details are identified, the consumer action coordinator circuitry 110 provides proposed return details to the consumer device 122 (232). The proposed return details may include return method (e.g., pick up or drop off), refund method (e.g., store credit, credit card refund, etc.), date for return, etc. In some examples, the consumer action coordinator circuitry 110 causes a user interface to be displayed to the consumer at the consumer device 122. In some examples, the user interface includes order information, fields including the proposed return details, a button to initiate return of selected items, and other options related to the order (e.g., warranty registration for the purchased items, order again, review a product included in the order, etc.).

In some examples, the consumer logs into an account with the consumer action coordinator circuitry 110. In such examples, the consumer action coordinator circuitry 110 records return preferences associated with a user account to generate proposed return details. For example, a consumer's preference to have returns picked up rather than dropping off the items to be returned at a location is associated with their account. In such an example, the consumer action coordinator circuitry 110 automatically sets the default proposed return method to pick up. The consumer edits and/or accepts the proposed return details (234). Once the consumer selects their preferred return details, the consumer requests coordination of the return by the consumer action coordinator circuitry 110 (236). The consumer action coordinator circuitry 110 coordinates a return with the retailer server 135 on behalf of the consumer 120 to determine a final destination for the product(s) (238). The consumer action coordinator circuitry 110 also determines a transit plan to transport the package to the final destination and initiates the transit plan. The consumer action coordinator circuitry 110 provides return instructions to the consumer 120 (240). For example, such instructions may communicate a time for pickup or drop off, indicate to the consumer that a courier service has been scheduled to retrieve the item, provide a shipping label to be used with the return package, etc. The consumer then carries out the return of the product(s) according to the return details. In some examples, the consumer action coordinator circuitry 110 re-coordinates the return of the item on behalf of the consumer if the return fails. For example, the consumer action coordinator circuitry 110 arranges the return again, with the same or different return details, if the consumer forgets to place the product(s) in the instructed location for a scheduled courier pick up.

In the illustrated example of FIG. 2, the region 230 enclosed by the dashed line represents actions particular to return of a product. However, the example sequence of FIG. 2 is applicable to other selectable actions that can be taken by the consumer (e.g., registering for a warranty, leaving a review, etc.). Such actions may be applicable to a product included in an order, to a service, etc. While the above description of the sequence from 232-240 is focused on coordination of a return on behalf of the consumer, the consumer action coordinator circuitry 110 may provide alternate information to the consumer device, to coordinate actions available to the consumer with respect to a product. Display of this information may include presenting a user interface to enable the consumer to select the action the user wishes to take, select a preference, and/or provide information. For example, the user interface may include the order information and at least one selectable consumer action. In some examples, the at least one selectable consumer action includes at least one of returning the product, registering a warranty for the product, leaving a review for the product, requesting a price deduction for the product, accessing a survey, ordering another of the product, extending a lease for the product, or making a donation. In some examples, the consumer action coordinator circuitry 110 modifies the user interface to at least one of add or remove a consumer action from the at least one selectable consumer action based on the consumer action modification request. In some examples, the consumer action coordinator circuitry 110 coordinates with the retailer server 135 and/or third-party systems to enable the consumer to complete a desired action. For example, the consumer action coordinator circuitry 110 may communicate with a third-party to obtain information pertaining to the warranty registration process for the product and then display that information to the consumer via the user interface.

The portion of the sequence in the dashed region 230 is tailored to the entity with which an action is being coordinated, the product for which an action is being coordinated, and/or the consumer. For example, one retailer may require specific steps, such as taking a picture of the product, to be completed by the consumer in order to coordinate a return, while another retailer does not. In that example, the sequence would include the consumer action coordinator circuitry 110 notifying the consumer 120 that a picture must be taken of the product before the return can be coordinated. The consumer action coordinator circuitry 110 would then continue to communicate with the retailer on the consumer's behalf to coordinate the rest of the details of the return.

FIG. 3 is a block diagram of an example implementation of the consumer action coordinator circuitry 110 of FIG. 1. The consumer action coordinator circuitry 110 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the consumer action coordinator circuitry 110 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

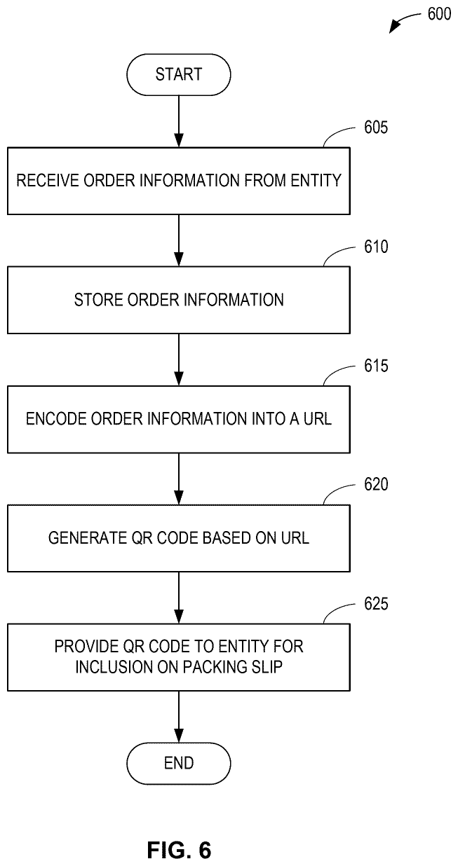

The example consumer action coordinator circuitry 110 of the illustrated example of FIG. 3 includes order information receiver circuitry 310, QR code generator 320, QR code provider 330, QR code validator circuitry 340, action setting proposer circuitry 350, action handler circuitry 360, and order information database 370. In some examples, the consumer action coordinator circuitry 110 is instantiated by programmable circuitry executing action coordination instructions and/or configured to perform operations such as those represented by the flowchart(s) of FIGS. 6, 7A, and 7B.

The example order information receiver circuitry 310 of the illustrated example of FIG. 3 receives order information from the third-party server 140 and/or the retailer server 135. The example third-party server 140 and/or the example retailer server 135 sends the order information to the consumer action coordinator circuitry 110 along with a request for a QR code. The retailer server 135 also sends options available to the consumer with respect to products purchased once the consumer receives the order. For example, the order information receiver circuitry may access a list of which consumer options will be available to the consumer when they scan the QR code. The example order information receiver circuitry 310 stores the order details and consumer options in the example order information database 370. For example, the consumer action coordinator circuitry 110 may store product information for each product in the order and the consumer options for each product in the order as a Boolean for each consumer option (e.g., return product, order product again, register warranty for product, etc.).

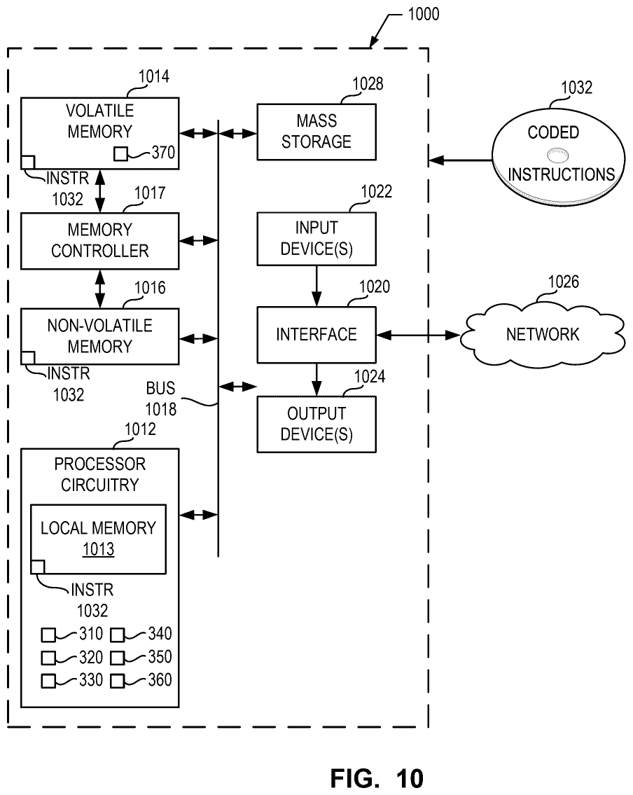

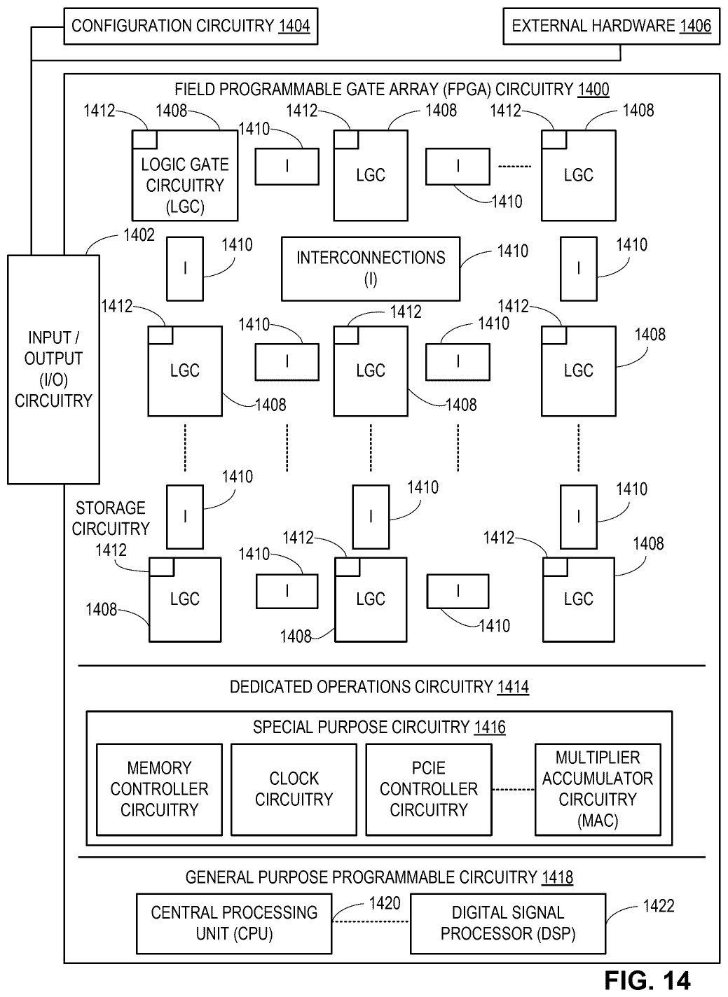

In some examples, the consumer action coordinator circuitry 110 includes means for receiving order information. For example, the means for receiving may be implemented by order information receiver circuitry 310. In some examples, the order information receiver circuitry 310 may be instantiated by programmable circuitry such as the example programmable circuitry 1012 of FIG. 10. For instance, the order information receiver circuitry 310 may be instantiated by the example microprocessor 1300 of FIG. 13 executing machine executable instructions such as those implemented by at least blocks 605, 610 of FIG. 6. In some examples, the order information receiver circuitry 310 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the order information receiver circuitry 310 may be instantiated by any other combination of hardware, software, and/or firmware. For example, the order information receiver circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example QR code generator 320 of the illustrated example of FIG. 3 generates a QR code based on order information for use by the retailer server 135. In some examples, the QR code generator 320 encodes the order information. In some examples, the QR code generator 320 encodes the order information into a URL and stores the URL in the order information database 370. In some examples, the information encoded into the URL is separate from the order information. In some examples, the URL identifies a webpage hosted by the consumer action coordinator circuitry 110. In some examples, the QR code generator 320 encodes the order information as a computed identifier (e.g., Globally Unique Identifier (GIUD), hash-based identifier, composite key, Collision-resistant Unique Identifier (CUID), Nano ID, etc.). For example, the QR code generator 320 generates a hash value based on the order information and creates a URL incorporating the hash value. The QR code generator 320 then associates the order information with the webpage that corresponds to the identification value. In some examples, the QR code generator 320 generates validation information (e.g., a validation code, a password, etc.) to be used during validation of the use of the QR code. For example, the QR code generator 320 generates a validation code (e.g., a four-digit number). In some examples, the validation information is generated based on the order information. In some examples, the QR code generator generates the QR code based on order information stored in the order information database 370. In some examples, the QR code generator generates the QR code based on the encoded URL that includes an identification value used to distinguish coordinator webpages from one another. In some examples, the QR code generator 320 generates multiple QR codes based on the order information. For example, the QR code generator 320 may generate a first QR code for a first product to be delivered to a first recipient and a second QR code for a second product to be delivered to a second recipient. In some examples, the QR code may be considered unique because the QR code generator 320 generates one QR code per webpage. The QR code may be any type, size, and/or resolution. In some examples, the QR code includes a visual component such as the logo of the managing organization (e.g., returned.com). In some examples, the QR code generator 320 ensures the generated QR code is not associated with an active action.

In some examples, the consumer action coordinator circuitry 110 includes means for generating QR codes. For example, the means for generating may be implemented by the QR code generator 320. In some examples, the QR code generator 320 may be instantiated by programmable circuitry such as the example programmable circuitry 1012 of FIG. 10. For instance, the QR code generator 320 may be instantiated by the example microprocessor 1300 of FIG. 13 executing machine executable instructions such as those implemented by at least blocks 615 and 620 of FIG. 6. In some examples, the QR code generator 320 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the QR code generator 320 may be instantiated by any other combination of hardware, software, and/or firmware. For example, the QR code generator 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example QR code provider 330 of the illustrated example of FIG. 3 provides the QR code(s) to the third-party server 140 and/or the retailer server 135. The retailer server 135 may then include the packing slip in a shipment to the consumer such that the consumer may later access a URL of the QR code to take an action for a product in the order. In some examples, the QR code provider 330 provides the QR code to the third-party server 140 and/or the retailer server 135 as a response to a web request received from the third-party server 140 and/or the retailer server 135. However, in some other examples, generation of the QR code may be delayed such that the QR code is made accessible to the third-party server 140 and/or the retailer server 135 at a later time (e.g., via a repository or other information exchange system).

In some examples, the consumer action coordinator circuitry 110 includes means for providing QR codes. For example, the means for providing may be implemented by the QR code provider 330. In some examples, the QR code provider 330 may be instantiated by programmable circuitry such as the example programmable circuitry 1012 of FIG. 10. For instance, the QR code provider 330 may be instantiated by the example microprocessor 1300 of FIG. 13 executing machine executable instructions such as those implemented by at least block 625 of FIG. 6. In some examples, the QR code provider 330 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the QR code provider 330 may be instantiated by any other combination of hardware, software, and/or firmware. For example, the QR code provider 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example QR code validator circuitry 340 of the illustrated example of FIG. 3 validates the use of the QR code on behalf of the retailer. In some examples, the QR code validator circuitry 340 receives a request at the URL encoded by the QR code. The QR code validator circuitry 340 validates the use of the QR code is legitimate by confirming the QR code was scanned by the consumer 120. In some examples, the QR code validator circuitry 340 uses two-factor authentication, a Completely Automated Public Turing test to tell Computers and Humans Apart (CAPTCHA), a validation code included in the packing slip, reviews history of IP addresses, poses security questions to the consumer 120, biometric identification, and/or performs any other method for validating the identity of the entity that scans the QR code. For example, a validation code may be included on the packing slip near the QR code (e.g., above, below, within, etc.). The QR code validator circuitry 340 requests the consumer 120 to enter the validation code to ensure the person accessing the URL is the person who received the shipment (e.g., the consumer 120). In some examples, the QR code validator circuitry 340 provides for alternative methods to perform validation and allows the consumer 120 to choose their preferred method. For example, the QR code validator circuitry 340 allows for two factor authentication by confirmation via text message, or, alternatively, by answering a security question. In some examples, the QR code validator circuitry 340 uses a preferred method of validation associated with a consumer profile of the consumer 120. In some examples, the QR code validator circuitry 340 notifies the third-party server 140 and/or the retailer server 135 of the use of the QR code. In some examples, the QR code validator circuitry 340 notifies the third-party server 140 and/or the retailer server 135 of the validated scan after the QR code use has been validated.

In some examples, the consumer action coordinator circuitry 110 includes means for validating QR codes. For example, the means for validating may be implemented by the QR code validator circuitry 340. In some examples, the QR code validator circuitry 340 may be instantiated by programmable circuitry such as the example programmable circuitry 1012 of FIG. 10. For instance, the QR code validator circuitry 340 may be instantiated by the example microprocessor 1300 of FIG. 13 executing machine executable instructions such as those implemented by at least block 705, 710, and 715 of FIG. 7. In some examples, the QR code validator circuitry 340 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the QR code validator circuitry 340 may be instantiated by any other combination of hardware, software, and/or firmware. For example, the QR code validator circuitry 340 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example action setting proposer circuitry 350 of the illustrated example of FIG. 3 generates proposed settings for use in coordination of a consumer action. In some examples, the proposed setting is generated using machine learning techniques including, for example, a neural network, a large language model, etc.

A large language model (LLM) operates by utilizing a neural network architecture known as a Transformer. LLMs are designed to understand and generate human-like text based on the vast amount of data on which the LLM has been trained. In the illustrated example of FIG. 3, the action setting proposer circuitry 350 may execute and/or cause execution of an LLM. Such an LLM may be executed and/or implemented locally at the consumer action coordinator circuitry 110 or at a computing system remote from the consumer action coordinator circuitry 110. For example, large language models may be executed in a cloud setting (e.g., remotely from the consumer action coordinator circuitry 110). Remote execution offers some advantages including, for example, that the LLM can be accessed from anywhere, providing scalability and ease of use. Cloud-based models are usually more powerful than locally executed models, as cloud-based models typically leverage high-performance hardware and are continuously updated with the latest improvements and fine-tuning. However, cloud-based models may raise concerns about data privacy, latency, and cost, as entities typically pay for the computational resources they consume (e.g., entities pay for use of the cloud-based model).

On the other hand, executing large language models locally provides an entity with more control over their data, and potentially lower latency for inference. Local execution can also work offline, which is beneficial in scenarios with limited Internet access or where data privacy is important. However, local execution typically requires powerful hardware, significant storage, and regular updates to maintain model performance.

In examples disclosed herein, the example action setting proposer circuitry 350 may execute and/or implement the LLM by generating a prompt that is provided to the LLM, and reviewing an output of the execution of the LLM. Additionally or alternatively, the action setting proposer circuitry 350 may be implemented using other techniques besides the use of an LLM to generate proposed settings. For example, programmed logic may be used in certain situations (e.g., to select a drop-off location having the closest proximity to the consumer), a neural network may be used to generate a proposal for a particular field, etc. Moreover, because different fields may have proposed settings generated by the action setting proposer circuitry 350, different techniques may be utilized to generate each different field. For example, a neural network approach may be used to propose whether the consumer will drop off the product at a location or have it picked up at a location of the consumer, whereas a large language model may be used to generate a proposed reason for a return.

In some examples, the consumer action coordinator circuitry 110 includes means for proposing a setting. For example, the means for proposing may be implemented by action setting proposer circuitry 350. In some examples, the action setting proposer circuitry 350 may be instantiated by programmable circuitry such as the example programmable circuitry 1012 of FIG. 10. For instance, the action setting proposer circuitry 350 may be instantiated by the example microprocessor 1300 of FIG. 13 executing machine executable instructions such as those implemented by at least blocks 720 and 725 of FIG. 7. In some examples, action setting proposer circuitry 350 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the action setting proposer circuitry 350 may be instantiated by any other combination of hardware, software, and/or firmware. For example, the action setting proposer circuitry 350 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example action handler circuitry 360 the illustrated example of FIG. 3 interacts with a retailer and/or third-party systems to obtain information and/or coordinate an action initiated by the consumer according to settings provided at the direction of the consumer. To do so, the example action handler circuitry 360 utilizes one or more machine learning models, LLMs, etc. to prepare messages to be used to interact with the retailer and/or third-party systems on behalf of the consumer. Such interaction may be conducted with the retailer and/or third-party systems via, for example, a web-based user interface, a chat bot, email messages, text messages, audio messages, etc. For example, the action handler circuitry 360 interacts with the retailer on behalf of the consumer to coordinate return of an item, and subsequently provides instructions to the consumer concerning completion of the return. Such instructions may indicate to the consumer that they are to place an item on their doorstep and that a courier service has been scheduled to retrieve the item.

In some examples, the consumer action coordinator circuitry 110 includes means for handling a consumer action. For example, the means for handling may be implemented by action handler circuitry 360. In some examples, the action handler circuitry 360 may be instantiated by programmable circuitry such as the example programmable circuitry 1012 of FIG. 10. For instance, the action handler circuitry 360 may be instantiated by the example microprocessor 1300 of FIG. 13 executing machine executable instructions such as those implemented by at least blocks 735, 740, and 745 of FIG. 7. In some examples, the action handler circuitry 360 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the action handler circuitry 360 may be instantiated by any other combination of hardware, software, and/or firmware. For example, the action handler circuitry 360 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

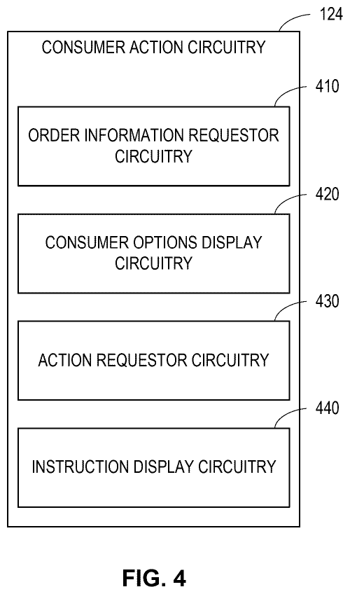

FIG. 4 is a block diagram of an example implementation of the consumer action circuitry 124 of FIG. 1. The consumer action circuitry 124 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the consumer action circuitry 124 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The example consumer action circuitry 124 of the illustrated example of FIG. 4 includes order information requestor circuitry 410, consumer options display circuitry 420, action requestor circuitry 430, and instruction display circuitry 440. In some examples, the consumer action circuitry 124 is instantiated by programmable circuitry executing consumer action instructions and/or configured to perform operations such as those represented by the flowchart of FIG. 2.

The example order information requestor circuitry 410 of the illustrated example of FIG. 4 obtains order information from the consumer action coordinator circuitry 110. The order information includes, for example, information associated with orders identified by the consumer action coordinator circuitry 110. In examples disclosed herein, the order information is formatted using JavaScript object notation (JSON). However, any other data format may additionally or alternatively be used to identify order information to the example order information requestor circuitry 410.

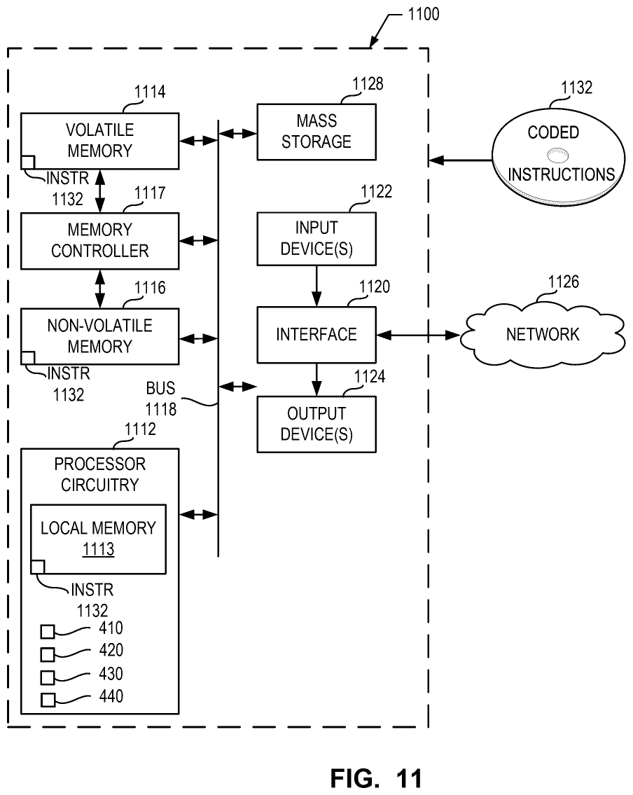

In some examples, the consumer action circuitry 124 includes means for obtaining order information. For example, the means for obtaining may be implemented by order information requestor circuitry 410. In some examples, the order information requestor circuitry 410 may be instantiated by programmable circuitry such as the example programmable circuitry 1112 of FIG. 11. For instance, the order information requestor circuitry 410 may be instantiated by the example microprocessor 1300 of FIG. 13 executing machine executable instructions such as those represented by the flowchart of FIG. 2. In some examples, the order information requestor circuitry 410 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the order information requestor circuitry 310 may be instantiated by any other combination of hardware, software, and/or firmware. For example, the order information requestor circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

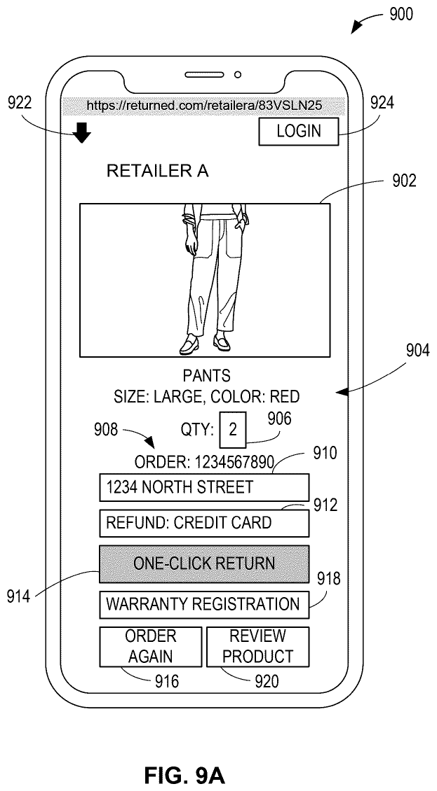

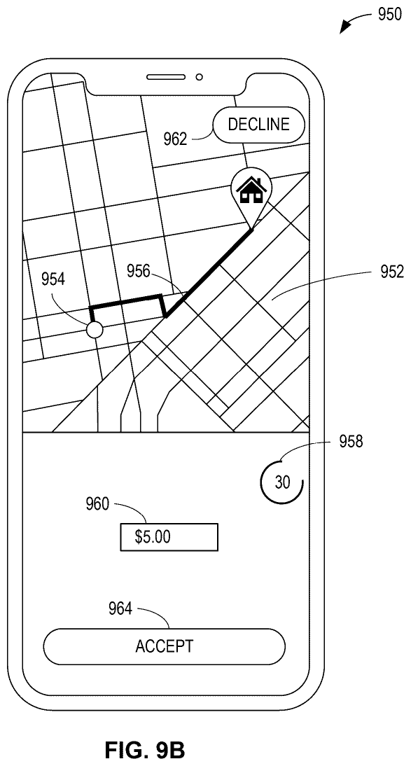

The example consumer options display circuitry 420 of the illustrated example of FIG. 4 causes display of a first user interface that identifies products and available actions for the products. Such a first user interface is disclosed below in connection with FIG. 9A. In some examples, the consumer options display circuitry 420 causes display of a second user interface that identifies settings to be used when coordinating the action. In some examples, when a consumer indicates their intent to select an action for a product, the example consumer options display circuitry 420 may review the selected values of various settings to confirm that any settings that are critical for coordination of the action (e.g., return of a product) are provided. In some examples, the first user interface and the second user interface are for a first QR code, and the example consumer options display circuitry 420 causes display of a third user interface to be displayed in response to a scan of a second QR code. In those examples, the consumer options display circuitry causes a fourth user interface to be displayed after selection of a second selected consumer action.

In some examples, the consumer action circuitry 124 includes means for causing display of a consumer options. For example, the means for causing may be implemented by consumer options display circuitry 420. In some examples, the consumer options display circuitry 420 may be instantiated by programmable circuitry such as the example programmable circuitry 1112 of FIG. 11. For instance, the consumer options display circuitry 420 may be instantiated by the example microprocessor 1300 of FIG. 13 executing machine executable instructions such as those represented by the flowchart of FIG. 2. In some examples, the consumer options display circuitry 420 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the consumer options display circuitry 420 may be instantiated by any other combination of hardware, software, and/or firmware. For example, the consumer options display circuitry 420 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example action requestor circuitry 430 of the illustrated example of FIG. 4 causes transmission of a request for coordination of an action to the consumer action coordinator circuitry 110. When requesting coordination of an action for the product, the example action requestor circuitry 430 provides the selected settings to the consumer action coordinator circuitry 110. In some examples, the example action requestor circuitry 430 may provide only those fields that deviated from the proposed action settings. In such examples, additional metadata including, for example, a reason for why the consumer 120 deviated from the proposed action setting may be included. Having stored the proposed settings, the consumer action coordinator circuitry 110 may recall the remaining proposed settings that the consumer did not modify, as those un-modified fields might not be included in the request to coordinate the action for the product.

In examples disclosed herein, the request for coordination of the action for the product is transmitted using a hypertext transfer protocol secure (HTTPS) message. However, any other messaging format and/or technology may additionally or alternatively be used such as, for example, hypertext transfer protocol (HTTP), Simple Object Access Protocol (SOAP), web sockets, etc. Such a message includes a payload that identifies the requested settings. In some examples, the payload is formatted using a JavaScript Object Notation (JSON). However, any other payload format may additionally or alternatively be used.

In some examples, the consumer action circuitry 124 includes means for requesting coordination of an action. For example, the means for requesting may be implemented by action requestor circuitry 430. In some examples, the action requestor circuitry 430 may be instantiated by programmable circuitry such as the example programmable circuitry 1112 of FIG. 11. For instance, the action requestor circuitry 430 may be instantiated by the example microprocessor 1300 of FIG. 13 executing machine executable instructions such as those represented by the flowchart of FIG. 2. In some examples, the action requestor circuitry 430 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the action requestor circuitry 430 may be instantiated by any other combination of hardware, software, and/or firmware. For example, the action requestor circuitry 430 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example instruction display circuitry 440 of the illustrated example of FIG. 4 causes the consumer device 122 to present instructions to the consumer to enable completion of the requested action. In some examples, a status of an action being coordinated may additionally or alternatively be displayed.

In some examples, the consumer action circuitry 124 includes means for presenting instructions to a consumer. For example, the means for presenting may be implemented by instruction display circuitry 440. In some examples, the instruction display circuitry 440 may be instantiated by programmable circuitry such as the example programmable circuitry 1112 of FIG. 11. For instance, the instruction display circuitry 340 may be instantiated by the example microprocessor 1300 of FIG. 13 executing machine executable instructions. In some examples, the instruction display circuitry 440 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the instruction display circuitry 440 may be instantiated by any other combination of hardware, software, and/or firmware. For example, the instruction display circuitry 440 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

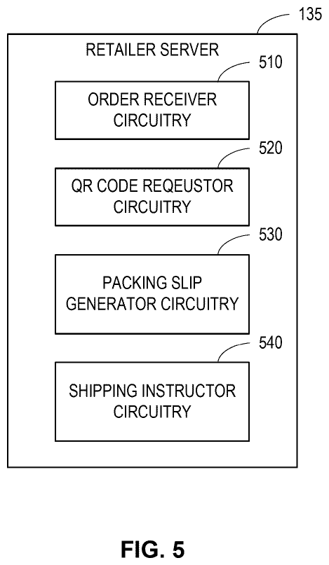

FIG. 5 is a block diagram of an example implementation of the retailer server 135 of FIG. 1. The retailer server 135 of FIG. 5 may be instantiated (e.g., creating an instance of, bring into being for any length of time, materialize, implement, etc.) by programmable circuitry such as a Central Processor Unit (CPU) executing first instructions. Additionally or alternatively, the retailer server 135 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

The example retailer server 135 of the illustrated example of FIG. 5 includes order receiver circuitry 510, QR code requestor circuitry 520, packing slip generator circuitry 530, and shipping instructor circuitry 540. In some examples, the retailer server 135 is instantiated by programmable circuitry executing consumer action instructions and/or configured to perform operations such as those represented by the flowchart of FIG. 2.

The example order receiver circuitry 510 of the illustrated example of FIG. 5 receives an order from the consumer 120. In some examples, the order information includes a name of the product, a weight of the product, a size of the product, a name of the retailer, an address of the retailer, a name of the purchaser, an address of the purchaser, etc.

In some examples, the retailer server 135 includes means for receiving orders. For example, the means for receiving may be implemented by order receiver circuitry 510. In some examples, the order receiver circuitry 510 may be instantiated by programmable circuitry such as the example programmable circuitry 1112 of FIG. 11. For instance, the order receiver circuitry 510 may be instantiated by the example microprocessor 1300 of FIG. 13 executing machine executable instructions such as those represented by the flowchart of FIG. 2. In some examples, the order receiver circuitry 510 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the order receiver circuitry 510 may be instantiated by any other combination of hardware, software, and/or firmware. For example, the order receiver circuitry 510 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example QR code requestor circuitry 520 of the illustrated example of FIG. 5 causes a request for a QR code for the order received by order receiver circuitry 510 to be sent to the consumer action coordinator circuitry 110. In some examples, the QR requestor circuitry 520 includes order information with the request for the QR code. In some examples, the QR requestor circuitry 520 requests multiple QR codes for an order.

In examples disclosed herein, the request for the QR code is transmitted using a hypertext transfer protocol secure (HTTPS) message. However, any other messaging format and/or technology may additionally or alternatively be used such as, for example, hypertext transfer protocol (HTTP), Simple Object Access Protocol (SOAP), web sockets, etc. Such a message includes a payload that identifies the order information. In some examples, the payload is formatted using a JavaScript Object Notation (JSON). However, any other payload format may additionally or alternatively be used.

In some examples, the retailer server 135 includes means for causing requesting a QR code from the consumer action coordinator circuitry 110. For example, the means for requesting may be implemented by QR code requestor circuitry 520. In some examples, the QR code requestor circuitry 520 may be instantiated by programmable circuitry such as the example programmable circuitry 1112 of FIG. 11. For instance, the QR code requestor circuitry 520 may be instantiated by the example microprocessor 1300 of FIG. 13 executing machine executable instructions such as those represented by the flowchart of FIG. 2. In some examples, the QR code requestor circuitry 520 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the QR code requestor circuitry 520 may be instantiated by any other combination of hardware, software, and/or firmware. For example, the QR code requestor circuitry 520 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example packing slip generator circuitry 530 of the illustrated example of FIG. 5 generates a packing slip including the QR code generated by the consumer action coordinator circuitry 110. In some examples, the packing slip generator circuitry 530 receives the QR code from the consumer action coordinator circuitry 110. In some examples, the packing slip generator circuitry 530 generates a packing slip including order information such as the shipping address, customer order number, product list, retailer information, etc. and the QR code. In some examples, the packing slip generator circuitry 530 prepares a packing slip that includes more than one QR code. In some examples, the packing slip generator circuitry 530 generates multiple packing slips for a single order (each of which may include one or more QR codes).

In some examples, the retailer server 135 includes means for generating packing slips. For example, the means for generating may be implemented by packing slip generator circuitry 530. In some examples, the packing slip generator circuitry 530 may be instantiated by programmable circuitry such as the example programmable circuitry 1112 of FIG. 11. For instance, the packing slip generator circuitry 530 may be instantiated by the example microprocessor 1300 of FIG. 13 executing machine executable instructions such as those represented by the flowchart of FIG. 2. In some examples, the packing slip generator circuitry 530 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the packing slip generator circuitry 530 may be instantiated by any other combination of hardware, software, and/or firmware. For example, the packing slip generator circuitry 530 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example shipping instructor circuitry 540 of the illustrated example of FIG. 5 causes the order to be shipped to the consumer 120. In some examples, the shipping instructor circuitry 540 coordinates with one or more logistics entities (e.g., a third party) to cause the shipment to be dispatched while including the packing slip.

In some examples, the retailer server 135 includes means for providing shipping instructions. For example, the means for providing may be implemented by shipping instructor circuitry 540. In some examples, the shipping instructor circuitry 540 may be instantiated by programmable circuitry such as the example programmable circuitry 1112 of FIG. 11. For instance, the shipping instructor circuitry 540 may be instantiated by the example microprocessor 1300 of FIG. 13 executing machine executable instructions. In some examples, the shipping instructor circuitry 540 may be instantiated by hardware logic circuitry, which may be implemented by an ASIC, XPU, or the FPGA circuitry 1400 of FIG. 14 configured and/or structured to perform operations corresponding to the machine readable instructions. Additionally or alternatively, the shipping instructor circuitry 540 may be instantiated by any other combination of hardware, software, and/or firmware. For example, the shipping instructor circuitry 540 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the consumer action coordinator circuitry 110 of FIG. 1 is illustrated in FIG. 3, one or more of the elements, processes, and/or devices illustrated in FIG. 3 may be combined, divided, re-arranged, omitted, eliminated, and/or implemented in any other way. Further, the example order information receiver circuitry 310, the example QR code generator 320, the example QR code provider 330, the example QR code validator circuitry 340, the example action setting proposer circuitry 350, the example action handler circuitry 360, and/or, more generally, the example consumer action coordinator circuitry 110 of FIG. 3, may be implemented by hardware alone or by hardware in combination with software and/or firmware. Thus, for example, any of the example order information receiver circuitry 310, the example QR code generator 320, the example QR code provider 330, the example QR code validator circuitry 340, the example action setting proposer circuitry 350, the example action handler circuitry 360, and/or, more generally, the example consumer action coordinator circuitry 110, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example consumer action coordinator circuitry 110 of FIG. 3 may include one or more elements, processes, and/or devices in addition to, or instead of, those illustrated in FIG. 3, and/or may include more than one of any or all of the illustrated elements, processes and devices.

Additionally, while an example manner of implementing the consumer action circuitry 124 of FIG. 1 is illustrated in FIG. 4, one or more of the elements, processes, and/or devices illustrated in FIG. 4 may be combined, divided, re-arranged, omitted, eliminated, and/or implemented in any other way. Further, the example order information requestor circuitry 410, the example consumer options display circuitry 420, the example action requestor circuitry 430 the example instruction display circuitry 440, and/or, more generally, the example consumer action circuitry 124 of FIG. 4, may be implemented by hardware alone or by hardware in combination with software and/or firmware. Thus, for example, any of the example order information requestor circuitry 410, the example consumer options display circuitry 420, the example action requestor circuitry 430 the example instruction display circuitry 440, and/or, more generally, the example consumer action circuitry 124, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example consumer action circuitry 124 of FIG. 4 may include one or more elements, processes, and/or devices in addition to, or instead of, those illustrated in FIG. 4, and/or may include more than one of any or all of the illustrated elements, processes and devices.

Additionally, while an example manner of implementing the retailer server 135 of FIG. 1 is illustrated in FIG. 5, one or more of the elements, processes, and/or devices illustrated in FIG. 5 may be combined, divided, re-arranged, omitted, eliminated, and/or implemented in any other way. Further, the example order receiver circuitry 510, the example QR code requestor circuitry 520, the example packing slip generator circuitry 530, the example shipping instructor circuitry 540, and/or, more generally, the example retailer server 135 of FIG. 5, may be implemented by hardware alone or by hardware in combination with software and/or firmware. Thus, for example, any of the example order receiver circuitry 510, the example QR code requestor circuitry 520, the example packing slip generator circuitry 530, the example shipping instructor circuitry 540, and/or, more generally, the example retailer server 135, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example retailer server of FIG. 5 may include one or more elements, processes, and/or devices in addition to, or instead of, those illustrated in FIG. 5, and/or may include more than one of any or all of the illustrated elements, processes and devices.

Flowchart(s) representative of example machine readable instructions, which may be executed by programmable circuitry to implement and/or instantiate the consumer action coordinator circuitry 110 of FIG. 3 and/or representative of example operations which may be performed by programmable circuitry to implement and/or instantiate the consumer action coordinator circuitry 110 of FIG. 3, are shown in FIGS. 6, 7A, and/or 7B. The machine readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 13 and/or 14. In some examples, the machine readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6, 7A, and/or 7B, many other methods of implementing the example consumer action coordinator circuitry 110 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6, 7A, and/or 7B may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by example programmable circuitry to implement the consumer action coordinator circuitry 110 of FIG. 1 to generate a QR code for an order. The example process 600 of the illustrated example of FIG. 6 begins when the example order information receiver circuitry 310 receives order information from a retailer from the third-party server 140 or the retailer server 135 (Block 605).

Once the example order information receiver circuitry 310 gathers order information from the retailer server 135 and/or the third-party server 140, the example order information receiver circuitry 310 stores the order information (Block 610). In examples disclosed herein, the order information is stored in the example order information database 370. However, the order information may be stored in any other location. Order information obtained from a retailer server might include order information specific only to the retailer operating the corresponding retailer server (or perhaps a collection of related retailers). After the order information is stored, the example QR code generator 320 encodes the order information into a URL (Block 615). In some examples, the URL includes an identification value to distinguish the webpage from another coordinator webpage. In some examples, the URL points to a webpage hosted by the consumer action coordinator circuitry 110. The example QR code generator 320 then associates the order information with the webpage that corresponds to the identification value. After the order information is encoded into the URL, the example QR code generator 320 generates a QR code based on the URL (Block 620). At Block 625, the example QR code provider 330 provides the QR code to the retailer for inclusion on a packing slip that will be sent to the consumer 120 in an order shipment. The example process 600 of FIG. 6 then terminates. The example process 600 of FIG. 6 and/or a portion thereof may then be repeated at a later time to enable subsequent collection of future order information.

FIG. 7A is a flowchart representative of example machine readable instructions and/or example operations that may be executed, instantiated, and/or performed by example programmable circuitry to implement the consumer action coordinator circuitry 110 of FIG. 1 to provide proposed return coordination details to the consumer action circuitry 124 of FIG. 1. The example process 700 of the illustrated example of FIG. 7 begins when the example QR code validator circuitry 340 receives a request at the URL encoded by the QR code. (Block 705). In response to receiving a request at the URL, the example QR code validator circuitry 340 validates the use of the QR code on behalf of the retailer (Block 710). In some examples, the example QR code validator circuitry 340 validates the use of the QR code via two-factor authentication, posing security questions to consumer 120, biometric authentication, and/or any other known method of authentication. In some examples, the QR code validator circuitry 340 uses a preferred method of validation associated with a consumer profile of the consumer 120. After validating the use of the QR code, the example QR code validator circuitry 340 notifies the third-party server 140 and/or the retailer server 135 of the use of the QR code (Block 715). The example action setting proposer circuitry 350 then identifies proposed settings (Block 720). In the case of return of a product, the proposed settings are proposed return coordination details. The proposed settings may be entity level defaults (e.g., defaults known to have a high success rate with a particular entity), order-level defaults (e.g., a second consumer action for a second product of an order may have default settings corresponding to settings selected by the consumer for a first consumer action for a first product of the order), item-level defaults, etc. For example, the product to be returned may be particularly fragile and require a special courier service for pick up.

In some examples, the proposed settings are generated using machine learning techniques including, for example, a neural network, a large language model, etc. In some examples, the action handler circuitry 360 identifies consumer history and/or consumer information to be used in generation of the proposed settings. Such consumer information may include return information such as, for example, drop-off location preferences, pick-up timing preferences, refund preferences, a current location of the consumer (e.g., based on global positioning system (GPS) coordinates included in the request message), a typical location of the consumer (e.g., historical address(es) of the consumer, a home address for the consumer, etc.), past consumer return preferences, consumer timing preferences, etc. In some examples, the action handler circuitry identifies retailer information to be used in generation of the proposed settings. Such retailer information may include, for example, drop-off location preferences, shipping service provider preferences, past retailer return preferences, etc.

In some examples, the action setting proposer circuitry 350 contacts the retailer and or third parties to identify whether a setting is available. For example, the return setting proposer circuitry 350 may contact a food bank that is local to the consumer if the consumer is attempting to return a food item that might instead be donated if in an acceptable condition (e.g., is not expired, damaged, etc.).

Using the identified order information, retailer information, and/or consumer information, the example action handler circuitry 360 employs techniques such as machine learning, artificial intelligence, and/or large language models to generate the proposed setting(s). Advantageously, such approaches can be trained and/or adapt over time to account for changing consumer preferences, new policies, additional fields to be used, newly available pick-up services, availability for recycling, resale, and/or other services that may be provided, etc. By generating the proposed settings, the example action handler circuitry 360 improves efficiency of the consumer and the retailer in identifying their desire for how the consumer action is to be coordinated. This reduces manual effort on the part of the consumer and the retailer and ensures that consumer actions are completed efficiently and effectively. By analyzing past interactions with retailers and consumers, as well as considering other relevant factors, the example action handler circuitry 360 can propose tailored settings.

The proposed settings are adaptable based on real-time data inputs, allowing the action handler circuitry 360 circuitry to continuously learn from past interactions with retailers and/or consumers, and improve the proposed settings over time. This ensures that consumers receive accurate and up-to-date recommendations of settings when instructing the consumer action coordinator circuitry 110 to coordinate consumer actions with a retailer. Furthermore, by incorporating large language models into the system, the example action handler circuitry 360 can better understand contextual information and generate more precise proposals for various fields.

The proposed settings may be defaults associated with a particular entity (e.g., the retailer, the consumer), defaults associated with a particular order, defaults for a geographic region, etc. The example action setting proposer circuitry 350 then provides the order information and proposed settings to the consumer device (Block 725). The example process 700 of FIG. 7A then terminates. The example process 700 of FIG. 7A and/or a portion thereof may then be repeated at a later time to enable proposing return coordination details for subsequent returns to the consumer action circuitry 124 of FIG. 1. The example process 700 of FIG. 7A may be altered to coordinate consumer actions other than return of an item. For example, the example process may be applicable to other actions (e.g., registering for a warranty, leaving a review, etc.) that can be taken by the consumer.

FIG. 7B is a flowchart representative of example machine readable instructions and/or example operations that may be executed, instantiated, and/or performed by example programmable circuitry to implement the consumer action coordinator circuitry 110 of FIG. 1 to interact with retailer or third party to coordinate a consumer action. The example process 730 of the illustrated example of FIG. 7B begins when the example action handler circuitry 360 receives a request to coordinate a consumer action with the retailer or another entity on behalf of the consumer 120 (Block 735). In some examples, the action handler circuitry 360 utilizes one or more machine learning models to prepare messages to be used to interact with the retailer on behalf of the consumer 120. The example action handler circuitry 360 then interacts with the retailer on behalf of the consumer to coordinate completion of the consumer action (Block 740). For example, the example action handler circuitry may interact with a retailer to determine the retailers preferred process for return of a product. The example action handler circuitry 360 then provides instructions to the consumer (Block 745). For example, such instructions may be return instructions indicating to the consumer that they are to place an item on their doorstep and that a courier service has been scheduled to retrieve the item.

The example process 730 of FIG. 7B then terminates. The example process 730 of FIG. 7B and/or a portion thereof may then be repeated at a later time to enable interaction with an entity to coordinate subsequent consumer actions.

FIG. 8 is an illustrative example of a packing slip 800 generated by the example retailer server 135 of FIG. 1 with an example QR code generated by the consumer action coordinator circuitry 110 of FIG. 1. The example packing slip 800 includes an example QR code 802. The example packing slip also includes the example consumer information 804, the example order information 806, and the example retailer information 808. The example packing slip 800 is included in the order shipment to the consumer 120. The consumer 120 scans the example QR code 802 to access a URL to initiate a consumer action for the item. For example, the consumer 120 scans the QR code to order the item again, register a warranty for the item, leave a review of the item, etc. In some examples, any of the example consumer information 804, the example order information 806, and the example retailer information 808 is used in validation of the use of the QR code.

FIG. 9A is an illustrative example of a consumer device accessing a URL hosted by the consumer action coordinator circuitry of FIG. 1 to display items for which consumer actions can be taken. In some examples, an example user interface 900 of the illustrated example of FIG. 9A may be referred to as an order page. That is, all the products associated with an order associated with the webpage may be displayed in one common location. In the illustrated example of FIG. 9A, the order consists only of a first item (e.g. a pair of pants) that had been purchased from an online retailer, but an order may consist of multiple products. In some examples, consumers are enabled to sort and/or search within the user interface 900 to find products from the order that are eligible for any one of available consumer actions. The example user interface 900 includes an example image 902 of the product, an example description 904 of the product, an example quantity 906 of the product, an example order number 908 for the order, an example first setting field 910, an example second setting field 912, an example one-click return button 914, an example order again button 916, an example warranty registration button 918, and example review product button 920, an example app download button 922, and an example log-in button 924.

In the illustrated example of FIG. 9A, the first setting field 910 corresponds to a return address. In the illustrated example of FIG. 9A, the second setting field 912 corresponds to a desired method of refund. In some examples, the user interface 900 includes more or fewer setting fields. In some examples, the user interface 900 includes alternative setting fields. For example, the user interface may include a setting field for a desired return date and/or time. In some examples, the setting fields 210, 212 are automatically set to a default setting based on retailer information, consumer information, and order information.

The consumer 120 clicks the example one-click return button 914 to initiate return of the selected product(s) according to the return settings designated in the example setting fields 210, 212. The consumer 120 clicks the example order again 916 button to order the selected product(s) again. The consumer 120 clicks the example warranty registration button 918 to register a warranty for the selected product(s). The consumer clicks the example review product button 920 to leave a review of the selected product(s).

FIG. 9B is an illustrative example of a consumer device accessing a URL hosted by the consumer action coordinator circuitry of FIG. 1 to display tracking for a return of an item. In some examples, an example user interface 950 of the illustrated example of FIG. 9B may be referred to as a tracking page. The example user interface 950 includes an example map 952, an example tracker location 954 for a pickup entity, an example travel path 956 for the pickup entity, an example time to arrival 958, an example estimated cost 960, an example cancellation button 962, and an example accept button 964. In some examples, the user interface 950 includes additional information regarding the return progress. In the illustrated example of FIG. 9B, the map 952, the tracker location 954 for the pickup entity, the travel path 956 for the pickup entity, the estimated time of arrival 958, and the estimated cost 960 provide information to the consumer 120 to optimize the return process. If the consumer 120 decides they do not want to return the item according to the information provided in the user interface 950 (for example, if they cannot produce the product to be returned at the designated time of arrival 958), the consumer 120 presses the example cancellation button 962 to cancel the return process. The consumer 120 may then reinitiate the return process with alternative settings. If the consumer 120 wishes to proceed with the proposed return process, the consumer 120 presses the accept button 964 to accept the proposed return.

FIG. 10 is a block diagram of an example programmable circuitry platform 1000 structured to execute and/or instantiate the example machine-readable instructions and/or the example operations of FIGS. 6, 7A, and/or 7B to implement the consumer action coordinator circuitry 110 of FIG. 2. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements the example order information receiver circuitry 310, the example QR code generator 320, the example QR code provider 330, the example QR code validator circuitry 340, the action setting proposer circuitry 350, and the example action handler circuitry 360.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 6, 7A, and/or 7B, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example programmable circuitry platform 1100 structured to execute and/or instantiate the example machine-readable instructions and/or the example operations represented by the flowchart of FIG. 2 to implement the consumer action circuitry 124 of FIG. 4. The programmable circuitry platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the example order information requestor circuitry 410, the example consumer options display circuitry 420, the example action requestor circuitry 430, and the example instruction display circuitry 440.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions represented by the flowchart of FIG. 2, may be stored in the mass storage device 1128, in the volatile memory 1114, in the non-volatile memory 1116, and/or on at least one non-transitory computer readable storage medium such as a CD or DVD which may be removable.

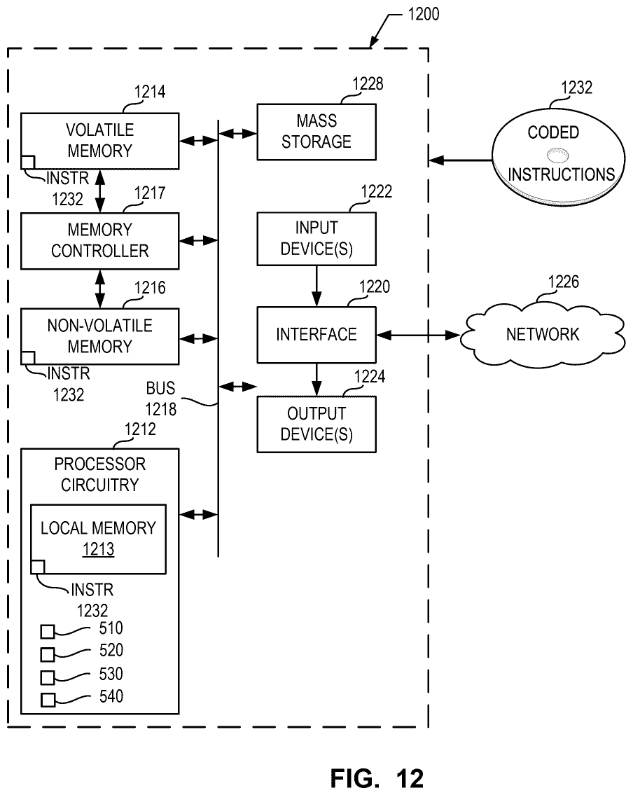

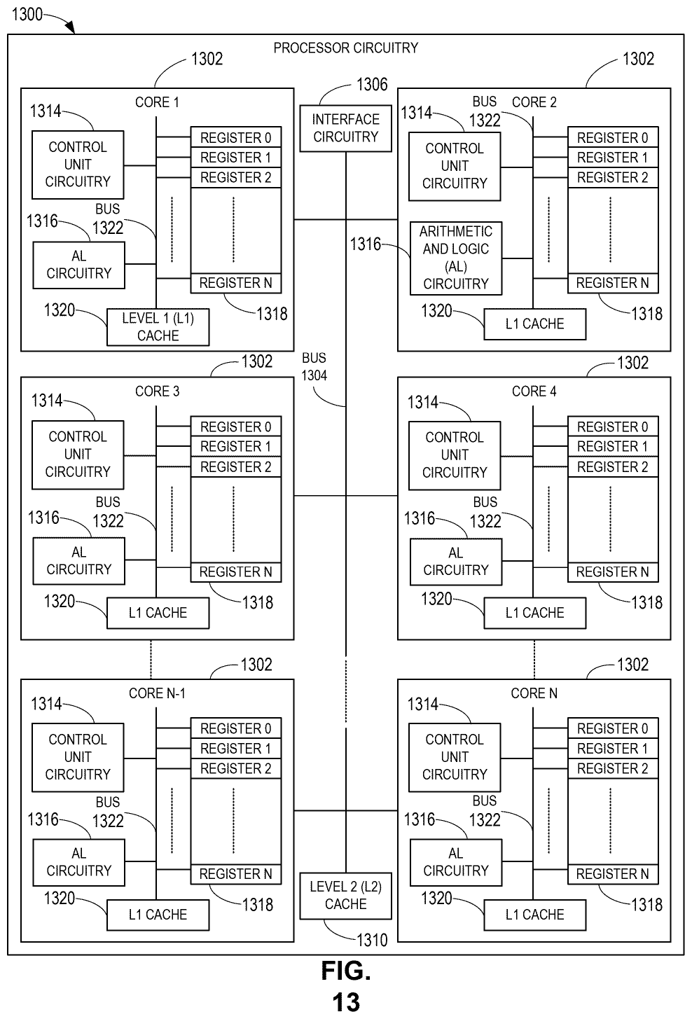

FIG. 12 is a block diagram of an example programmable circuitry platform 1200 structured to execute and/or instantiate the example machine-readable instructions and/or the example operations represented by the flowchart of FIG. 2 to implement the retailer server 135 of FIG. 5. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD console, a personal video recorder, a set top box, a headset (e.g., an augmented reality (AR) headset, a virtual reality (VR) headset, etc.) or other wearable device, or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs, microprocessors, CPUs, GPUs, DSPs, and/or microcontrollers from any desired family or manufacturer. The programmable circuitry 1212 may be implemented by one or more semiconductor based (e.g., silicon based) devices. In this example, the programmable circuitry 1212 implements the example order receiver circuitry 510, the example QR code requestor circuitry 520, the example packing slip generator circuitry 530, and the example shipping instructor circuitry 540.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1200 of the illustrated example also includes one or more mass storage discs or devices 1228 to store firmware, software, and/or data. Examples of such mass storage discs or devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1232, which may be implemented by the machine readable instructions represented by the flowchart of FIG. 2, may be stored in the mass storage device 1228, in the volatile memory 1214, in the non-volatile memory 1216, and/or on at least one non-transitory computer readable storage medium such as a CD or DVD which may be removable.

FIG. 13 is a block diagram of an example implementation of the programmable circuitry 1012 of FIG. 10, the programmable circuitry 1112 of FIG. 11, or the programmable circuitry 1212 of FIG. 12. In this example, the programmable circuitry of FIG. 10 or 11 is implemented by a microprocessor 1300. For example, the microprocessor 1300 may be a general-purpose microprocessor (e.g., general-purpose microprocessor circuitry). The microprocessor 1300 executes some or all of the machine-readable instructions of the flowcharts of FIGS. 6, 7A and/or 7B to effectively instantiate the circuitry of FIGS. 1, 2, 3, 4, and/or 5 as logic circuits to perform operations corresponding to those machine readable instructions. In some such examples, the circuitry of FIG. 3, 4, or 5 is instantiated by the hardware circuits of the microprocessor 1300 in combination with the machine-readable instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 6, 7A and/or 7B.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Additionally or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1014, 1016 of FIG. 10, the main memory 1114, 1116 of FIG. 11, the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating-point operations. In yet other examples, the AL circuitry 1316 may include first AL circuitry that performs integer-based operations and second AL circuitry that performs floating-point operations. In some examples, the AL circuitry 1316 may be referred to as an Arithmetic Logic Unit (ALU).

The registers 1318 are semiconductor-based structures to store data and/or instructions such as results of one or more of the operations performed by the AL circuitry 1316 of the corresponding core 1302. For example, the registers 1318 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure, such as by being distributed throughout the core 1302 to shorten access time. The second bus 1322 may be implemented by at least one of an I2C bus, a SPI bus, a PCI bus, or a PCIe bus.

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages.

The microprocessor 1300 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1300, in the same chip package as the microprocessor 1300 and/or in one or more separate packages from the microprocessor 1300.

FIG. 14 is a block diagram of another example implementation of the programmable circuitry 1012 of FIG. 10, the programmable circuitry 1112 of FIG. 11, or the programmable circuitry 1212 of FIG. 12. In this example, the programmable circuitry 1012 or the programmable circuitry 1112 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine readable instructions represented by the flowchart(s) of FIGS. 6, 7A and/or 7B but whose interconnections and logic circuitry are fixed once fabricated), the FPGA circuitry 1400 of the example of FIG. 14 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6, 7A and/or 7B. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6, 7A and/or 7B. As such, the FPGA circuitry 1400 may be configured and/or structured to effectively instantiate some or all of the operations/functions corresponding to the machine readable instructions of the flowchart(s) of FIGS. 6, 7A and/or 7B as dedicated logic circuits to perform the operations/functions corresponding to those software instructions in a dedicated manner analogous to an ASIC. Therefore, the FPGA circuitry 1400 may perform the operations/functions corresponding to the some or all of the machine readable instructions of FIGS. 6, 7A and/or 7B faster than the general-purpose microprocessor can execute the same.

In the example of FIG. 14, the FPGA circuitry 1400 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain a binary file, which may be implemented by a bit stream, data, and/or machine-readable instructions, to configure the FPGA circuitry 1400, or portion(s) thereof. In some such examples, the configuration circuitry 1404 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1406 may be implemented by external hardware circuitry. For example, the external hardware 1406 may be implemented by the microprocessor 1300 of FIG. 13.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to at least some of the machine readable instructions of FIGS. 6, 7A and/or 7B and/or other desired operations. The logic gate circuitry 1408 shown in FIG. 14 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations/functions. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example dedicated operations circuitry 1414. In this example, the dedicated operations circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the programmable circuitry 1012 of FIG. 10, many other approaches are contemplated. For example, FPGA circuitry may include an on-board CPU, such as one or more of the example CPU 1420 of FIG. 14. Therefore, the programmable circuitry 1012 of FIG. 10, the programmable circuitry 1112 of FIG. 11, and/or the programmable circuitry 1212 of FIG. 12 may additionally be implemented by combining at least the example microprocessor 1200 of FIG. 13 and the example FPGA circuitry 1400 of FIG. 14. In some such hybrid examples, one or more cores 1302 of FIG. 13 may execute a first portion of the machine readable instructions represented by the flowchart(s) of FIGS. 6, 7A, and/or 7B to perform first operation(s)/function(s), the FPGA circuitry 1400 of FIG. 14 may be configured and/or structured to perform second operation(s)/function(s) corresponding to a second portion of the machine readable instructions represented by the flowcharts of FIGS. 6, 7A and/or 7B, and/or an ASIC may be configured and/or structured to perform third operation(s)/function(s) corresponding to a third portion of the machine readable instructions represented by the flowcharts of FIGS. 6, 7A and/or 7B.

It should be understood that some or all of the circuitry of FIGS. 3, 4, and/or 5 may, thus, be instantiated at the same or different times. For example, same and/or different portion(s) of the microprocessor 1300 of FIG. 13 may be programmed to execute portion(s) of machine-readable instructions at the same and/or different times. In some examples, same and/or different portion(s) of the FPGA circuitry 1400 of FIG. 14 may be configured and/or structured to perform operations/functions corresponding to portion(s) of machine-readable instructions at the same and/or different times.

In some examples, some or all of the circuitry of FIGS. 3, 4, and/or 5 may be instantiated, for example, in one or more threads executing concurrently and/or in series. For example, the microprocessor 1300 of FIG. 13 may execute machine readable instructions in one or more threads executing concurrently and/or in series. In some examples, the FPGA circuitry 1400 of FIG. 14 may be configured and/or structured to carry out operations/functions concurrently and/or in series. Moreover, in some examples, some or all of the circuitry of FIGS. 3, 4, and/or 5 may be implemented within one or more virtual machines and/or containers executing on the microprocessor 1300 of FIG. 13.

In some examples, the programmable circuitry 1012 of FIG. 10, the programmable circuitry 1112 of FIG. 11, or the programmable circuitry 1212 of FIG. 12 may be in one or more packages. For example, the microprocessor 1300 of FIG. 13 and/or the FPGA circuitry 1400 of FIG. 14 may be in one or more packages. In some examples, an XPU may be implemented by the programmable circuitry 1012 of FIG. 10, the programmable circuitry 1112 of FIG. 11, or the programmable circuitry 1212 of FIG. 12, which may be in one or more packages. For example, the XPU may include a CPU (e.g., the microprocessor 1300 of FIG. 13, the CPU 1420 of FIG. 14, etc.) in one package, a DSP (e.g., the DSP 1422 of FIG. 14) in another package, a GPU in yet another package, and an FPGA (e.g., the FPGA circuitry 1400 of FIG. 14) in still yet another package.

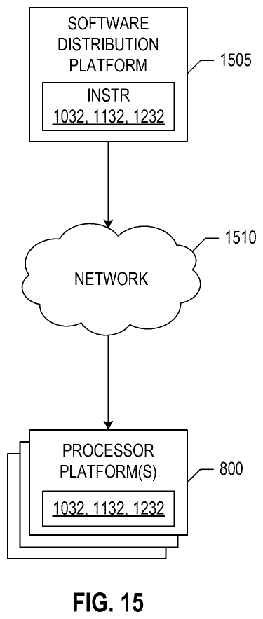

A block diagram illustrating an example software distribution platform 1505 to distribute software such as the example machine readable instructions 1032 of FIG. 10, the example machine readable instructions 1132 of FIG. 11, or the example machine readable instructions 1232 of FIG. 12 to other hardware devices (e.g., hardware devices owned and/or operated by third parties from the owner and/or operator of the software distribution platform) is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1032 of FIG. 10, the example machine readable instructions 1132 of FIG. 11, or the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the example machine readable instructions 1032, the example machine readable instructions 1132, or the example machine readable instructions 1232 which may correspond to the example machine readable instructions of FIGS. 6, 7A, and/or 7B, as described above. The one or more servers of the example software distribution platform 1505 are in communication with an example network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the example machine readable instructions 1032, the example machine readable instructions 1132, or the example machine readable instructions 1232 from the software distribution platform 1505. For example, the software, which may correspond to the example machine readable instructions of FIGS. 6, 7A and/or 7B, may be downloaded to the example programmable circuitry platform 1000 or the example programmable circuitry platform 1100, which is to execute the machine readable instructions 1032, 1132, 1232 to implement the consumer action coordinator circuitry 110 or the consumer action circuitry 124. In some examples, one or more servers of the software distribution platform 1505 periodically offer, transmit, and/or force updates to the software (e.g., the example machine readable instructions 1032 of FIG. 10, the example machine readable instructions 1132 of FIG. 11, or the example machine readable instructions 1232 of FIG. 12) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable efficient coordination of consumer actions for a product. Disclosed systems, apparatus, articles of manufacture, and methods improve the efficiency of using a computing device by generating proposed settings to be presented to a user, thereby reducing the amount of time a user must spend filling in each field individually and computing resources associated with receiving and recording user inputs. Disclosed systems, apparatus, articles of manufacture, and methods are accordingly directed to one or more improvement(s) in the operation of a machine such as a computer or other electronic and/or mechanical device.

Example 1 includes at least one non-transitory machine-readable medium comprising instructions that cause at least one processor circuit to at least: generate a quick-response (QR) code based on order information corresponding to an order for a product from a retailer, the retailer being at least one entity included in a sale or a provision of a good or service; provide the QR code to the retailer, the retailer to include the QR code in a shipment of the order; cause display of a first user interface in response to a scan of the QR code, the first user interface including the order information and one or more selectable consumer actions; and after selection of a selected consumer action of the one or more selectable consumer actions, cause coordination of the selected consumer action.

Example 2 includes the at least one non-transitory machine-readable medium of example 1, wherein the instructions are to cause one or more of the at least one processor circuit to: receive a QR code request from the retailer, the QR code request to include the order information; and store the order information.

Example 3 includes the at least one non-transitory machine-readable medium of example 1 or example 2, wherein the QR code request identifies the one or more selectable consumer actions for the product and the instructions are to cause one or more of the at least one processor circuit to store the one or more selectable consumer actions.

Example 4 includes the at least one non-transitory machine-readable medium of any one of examples 1-3, wherein the instructions are to cause one or more of the at least one processor circuit to encode the order information to generate a computed identifier, the generation of the QR code based on the computed identifier.

Example 5 includes the at least one non-transitory machine-readable medium of any one of examples 1-4, wherein the instructions are to cause one or more of the at least one processor circuit to generate a URL including the computed identifier.

Example 6 includes the at least one non-transitory machine-readable medium of any one of examples 1-5, wherein the instructions are to cause one or more of the at least one processor circuit to validate the scan of the QR code prior to causing display of the first user interface.

Example 7 includes the at least one non-transitory machine-readable medium of any one of examples 1-6, wherein the instructions are to cause one or more of the at least one processor circuit to validate the scan of the QR code using at least one of two-factor authentication, at least one security question, biometric authentication, or a validation code included in a shipment of the order.

Example 8 includes the at least one non-transitory machine-readable medium of any one of examples 1-7, wherein the instructions are to cause one or more of the at least one processor circuit to notify the retailer of the validated scan of the QR code.

Example 9 includes the at least one non-transitory machine-readable medium of any one of examples 1-8, wherein the one or more selectable consumer actions includes at least one of returning the product, registering a warranty for the product, leaving a review for the product, requesting a price deduction for the product, accessing a survey, ordering another of the product, extending a lease for the product, or making a donation.

Example 10 includes the at least one non-transitory machine-readable medium of any one of examples 1-9, wherein the QR code is a first QR code, the one or more selectable consumer actions is a first selectable consumer action, the selected consumer action is a first selected consumer action, and wherein the instructions are to cause one or more of the at least one processor circuit to: generate a second QR code based on the order information; cause display of a second user interface in response to a scan of the second QR code, the second user interface including the order information and a second selectable consumer action; and after selection of the second selectable consumer action cause coordination of the second selectable consumer action.

Example 11 includes the at least one non-transitory machine-readable medium of one any of examples 1-10, wherein the order information includes at least one of a name of the product, a weight of the product, a size of the product, a name of the retailer, an address of the retailer, a name of a recipient, or a shipping address.

Example 12 includes the at least one non-transitory machine-readable medium of one any of examples 1-11, wherein the instructions are to cause one or more of the at least one processor circuit to: receive a consumer action modification request from the retailer after generation of the QR code; and modify the first user interface to at least one of add or remove a consumer action from the one or more selectable consumer actions based on the consumer action modification request.

Example 13 includes the at least one non-transitory machine-readable medium of any one of examples 1-12, wherein the QR code is unique to the order and a recipient of the product.

Example 14 includes an apparatus including: interface circuitry; machine-readable instructions; and at least one processor circuit to be programmed by the machine-readable instructions to: generate a quick-response (QR) code based on order information corresponding to an order for a product from a retailer, the retailer being at least one entity included in a sale or a provision of a good or service; provide the QR code to the retailer, the retailer to include the QR code in a shipment of the order; cause display of a first user interface in response to a scan of the QR code, the first user interface including the order information and one or more selectable consumer actions; and after selection of a selected consumer action of the one or more selectable consumer actions, cause coordination of the selected consumer action.

Example 15 includes the apparatus of example 14, wherein one or more of the at least one processor circuit is to: receive a QR code request from the retailer, the QR code request to include the order information; and store the order information.

Example 16 includes the apparatus of example 14 or example 15, wherein the QR code request identifies the one or more selectable consumer actions for the product and one or more of the at least one processor circuit is to store the one or more selectable consumer actions.

Example 17 includes the apparatus of any one of examples 14-16, wherein one or more of the at least one processor circuit is to encode the order information to generate a computed identifier, the generation of the QR code based on the computed identifier.

Example 18 includes the apparatus of any one of examples 14-17, wherein one or more of the at least one processor circuit is to generate a URL including the computed identifier.

Example 19 includes the apparatus of any one of examples 14-18, wherein one or more of the at least one processor circuit is to validate the scan of the QR code prior to causing display of the first user interface.

Example 20 includes the apparatus of any one of examples 14-19, wherein one or more of the at least one processor circuit is to validate the scan of the QR code using at least one of two-factor authentication, at least one security question, biometric authentication, or a validation code included in a shipment of the order.

Example 21 includes the apparatus of any one of examples 14-20, wherein one or more of the at least one processor circuit is to notify the retailer of the validated scan of the QR code.

Example 22 includes the apparatus of any one of examples 14-21, wherein the one or more selectable consumer actions includes at least one of returning the product, registering a warranty for the product, leaving a review for the product, requesting a price deduction for the product, accessing a survey, ordering another of the product, extending a lease for the product, or making a donation.

Example 23 includes the apparatus of any one of examples 14-22, wherein the QR code is a first QR code, the one or more selectable consumer actions is a first selectable consumer action, the selected consumer action is a first selected consumer action, and wherein one or more of the at least one processor circuit is to: generate a second QR code based on the order information; cause display of a second user interface in response to a scan of the second QR code, the second user interface including the order information and a second selectable consumer action; and after selection of the second selectable consumer action, cause coordination of the second selectable consumer action.

Example 24 includes the apparatus of any one of examples 14-23, wherein the order information includes at least one of a name of the product, a weight of the product, a size of the product, a name of the retailer, an address of the retailer, a name of a recipient, or a shipping address.

Example 25 includes the apparatus of any one of examples 14-24, wherein one or more of the at least one processor circuit is to: receive a QR code request from the retailer, the QR code request including the order information and the one or more selectable consumer actions; receive a consumer action modification request from the retailer after generation of the QR code; and modify the first user interface to at least one of add or remove a consumer action from the at least one selectable consumer action based on the consumer action modification request.

Example 26 includes the apparatus of any one of examples 14-25, wherein the QR code is unique to the order and a recipient of the product.

Example 27 includes a method including: generating a quick-response (QR) code based on order information corresponding to an order for a product from a retailer, the retailer being at least one entity included in a sale or a provision of a good or service; providing the QR code to the retailer, the retailer to include the QR code in a shipment of the order; causing display of a first user interface in response to a scan of the QR code, the first user interface including the order information and one or more selectable consumer actions; and after selection of a selected consumer action of the one or more selectable consumer actions, causing coordination of the selected consumer action.

Example 28 includes the method of example 27, further including: receiving a QR code request from the retailer, the QR code request to include the order information; and storing the order information.

Example 29 includes the method of example 27 or example 28, wherein the QR code request identifies the one or more selectable consumer actions for the product, and further including storing the one or more selectable consumer actions.

Example 30 includes the method of any one of examples 27-29, further including encoding the order information to generate a computed identifier, wherein the generating of the QR code is based on the computed identifier.

Example 31 includes the method of any one of examples 27-30, w further including generating a URL including the computed identifier.

Example 32 includes the method of any one of examples 27-31, further including validating the scan of the QR code prior to causing display of the first user interface.

Example 33 includes the method of any one of examples 27-32, further including validating the scan of the QR code using at least one of two-factor authentication, at least one security question, biometric authentication, or a validation code included in a shipment of the order.

Example 34 includes the method of any one of examples 27-33, further including notifying the retailer of the validated scan of the QR code.

Example 35 includes the method of any one of examples 27-34, wherein the one or more selectable consumer actions includes at least one of returning the product, registering a warranty for the product, leaving a review for the product, requesting a price deduction for the product, accessing a survey, ordering another of the product, extending a lease for the product, or making a donation.

Example 36 includes the method of any one of examples 27-35, wherein the QR code is a first QR code, the one or more selectable consumer actions is a first selectable consumer action, the selected consumer action is a first selected consumer action, and further including: generating a second QR code based on the order information; causing display of a second user interface in response to a scan of the second QR code, the second user interface including the order information and a second selectable consumer action; after selection of the second selectable consumer action, causing coordination of the second selectable consumer action.

Example 37 includes the method of any one of examples 27-36, wherein the order information includes at least one of a name of the product, a weight of the product, a size of the product, a name of the retailer, an address of the retailer, a name of a recipient, or a shipping address.

Example 38 includes the method of any one of examples 27-37, further including: receiving a QR code request from the retailer, the QR code request including the order information and the one or more selectable consumer actions; receiving a consumer action modification request from the retailer after generation of the QR code; and modifying the first user interface to at least one of add or remove a consumer action from the one or more selectable consumer actions based on the consumer action modification request.

Example 39 includes the method of any one of examples 27-38, wherein the QR code is unique to the order and a recipient of the product.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one non-transitory machine-readable medium comprising instructions that cause at least one processor circuit to at least:
generate a quick-response (QR) code based on order information corresponding to an order for a product from a retailer, the retailer being at least one entity included in a sale or a provision of a good or service;
provide the QR code to the retailer, the retailer to include the QR code in a shipment of the order;
cause display of a first user interface in response to a scan of the QR code, the first user interface including the order information and one or more selectable consumer actions; and
after selection of a selected consumer action of the one or more selectable consumer actions, cause coordination of the selected consumer action.

2. The at least one non-transitory machine-readable medium of claim 1, wherein the instructions are to cause one or more of the at least one processor circuit to:
receive a QR code request from the retailer, the QR code request to include the order information; and
store the order information.

3. The at least one non-transitory machine-readable medium of claim 2, wherein the QR code request identifies the one or more selectable consumer actions for the product and the instructions are to cause one or more of the at least one processor circuit to store the one or more selectable consumer actions.

4. The at least one non-transitory machine-readable medium of claim 1, wherein the instructions are to cause one or more of the at least one processor circuit to encode the order information to generate a computed identifier, the generation of the QR code based on the computed identifier.

5. The at least one non-transitory machine-readable medium of claim 4, wherein the instructions are to cause one or more of the at least one processor circuit to generate a URL including the computed identifier.

6. The at least one non-transitory machine-readable medium of claim 1, wherein the instructions are to cause one or more of the at least one processor circuit to validate the scan of the QR code prior to causing display of the first user interface.

7. The at least one non-transitory machine-readable medium of claim 6, wherein the instructions are to cause one or more of the at least one processor circuit to validate the scan of the QR code using at least one of two-factor authentication, at least one security question, biometric authentication, or a validation code included in a shipment of the order.

8. The at least one non-transitory machine-readable medium of claim 6, wherein the instructions are to cause one or more of the at least one processor circuit to notify the retailer of the validated scan of the QR code.

9. An apparatus comprising:
interface circuitry;
machine-readable instructions; and
at least one processor circuit to be programmed by the machine-readable instructions to:
generate a quick-response (QR) code based on order information corresponding to an order for a product from a retailer, the retailer being at least one entity included in a sale or a provision of a good or service;
provide the QR code to the retailer, the retailer to include the QR code in a shipment of the order;
cause display of a first user interface in response to a scan of the QR code, the first user interface including the order information and one or more selectable consumer actions; and
after selection of a selected consumer action of the one or more selectable consumer actions, cause coordination of the selected consumer action.

10. The apparatus of claim 9, wherein one or more of the at least one processor circuit is to validate the scan of the QR code prior to causing display of the first user interface.

11. The apparatus of claim 10, wherein one or more of the at least one processor circuit is to validate the scan of the QR code using at least one of two-factor authentication, at least one security question, biometric authentication, or a validation code included in a shipment of the order.

12. The apparatus of claim 10, wherein one or more of the at least one processor circuit is to notify the retailer of the validated scan of the QR code.

13. The apparatus of claim 9, wherein the one or more selectable consumer actions includes at least one of returning the product, registering a warranty for the product, leaving a review for the product, requesting a price deduction for the product, accessing a survey, ordering another of the product, extending a lease for the product, or making a donation.

14. The apparatus of claim 9, wherein the QR code is a first QR code, the one or more selectable consumer actions is a first selectable consumer action, the selected consumer action is a first selected consumer action, and wherein one or more of the at least one processor circuit is to:
generate a second QR code based on the order information;
cause display of a second user interface in response to a scan of the second QR code, the second user interface including the order information and a second selectable consumer action; and
after selection of the second selectable consumer action, cause coordination of the second selectable consumer action.

15. A method comprising:
generating a quick-response (QR) code based on order information corresponding to an order for a product from a retailer, the retailer being at least one entity included in a sale or a provision of a good or service;
providing the QR code to the retailer, the retailer to include the QR code in a shipment of the order;
causing display of a first user interface in response to a scan of the QR code, the first user interface including the order information and one or more selectable consumer actions; and
after selection of a selected consumer action of the one or more selectable consumer actions, causing coordination of the selected consumer action.

16. The method of claim 15, wherein the one or more selectable consumer actions includes at least one of returning the product, registering a warranty for the product, leaving a review for the product, requesting a price deduction for the product, accessing a survey, ordering another of the product, extending a lease for the product, or making a donation.

17. The method of claim 15, wherein the QR code is a first QR code, the one or more selectable consumer actions is a first selectable consumer action, the selected consumer action is a first selected consumer action, and further including:
generating a second QR code based on the order information;
causing display of a second user interface in response to a scan of the second QR code, the second user interface including the order information and a second selectable consumer action; and
after selection of the second selectable consumer action, causing coordination of the second selectable consumer action.

18. The method of claim 15, wherein the order information includes at least one of a name of the product, a weight of the product, a size of the product, a name of the retailer, an address of the retailer, a name of a recipient, or a shipping address.

19. The method of claim 15, further including:
receiving a QR code request from the retailer, the QR code request including the order information and the one or more selectable consumer actions;
receiving a consumer action modification request from the retailer after generation of the QR code; and
modifying the first user interface to at least one of add or remove a consumer action from the one or more selectable consumer actions based on the consumer action modification request.

20. The method of claim 15, wherein the QR code is unique to the order and a recipient of the product.
